(19) United States
(12) Patent Application Publication
(10) Pub. No.: US 2026/0286665 A1
(43) Pub. Date: Sep. 24, 2026

(54) DUAL-CONTROL FAUCET ASSEMBLY WITH BELOW-DECK MIXING BOX

(71) Applicant: AS America, Inc., Piscataway, NJ (US)

(72) Inventors: Xiaojing YE, Edison, NJ (US); Weijian ZHANG, Guangzhou (CN); David ESPIRITO SANTO, Colonia, NJ (US)

(73) Assignee: AS America, Inc., Piscataway, NJ (US)

(21) Appl. No.: 19/475,864

(22) PCT Filed: Apr. 17, 2024
(86) PCT No.: PCT/US2024/025056

§ 371 Date: Oct. 16, 2025

(30) Foreign Application Priority Data
Apr. 18, 2023 (WO) PCT/CN2023/088887

(51) Int. Cl. E03C 1/04; E03C 1/05; F16K 11/00; F16K 31/05

(52) U.S. Cl. CPC E03C 1/04; E03C 1/055; F16K 19/006; F16K 31/055

(57) ABSTRACT

Provided are faucet assemblies comprising: a faucet body; a control mechanism; and a mixing box configured to be located below a deck surface to which the faucet body is configured to be installed, wherein the mixing box comprises a first cartridge, a second cartridge, and a manifold assembly such that a central horizontal axis of the first cartridge and a central horizontal axis of the second cartridge are perpendicular to a central vertical axis of a manifold cover of the manifold assembly.

### CROSS-REFERENCE TO RELATED APPLICATION

This application claims the benefit of PCT International Application No. PCT/CN2023/088887, filed Apr. 18, 2023, the entire contents of which is incorporated herein by reference.

### FIELD

The present invention relates generally to fluid supply assemblies, and in particular, to faucet assemblies having a below-deck mixing box.

### BACKGROUND

Conventional faucet assemblies include multiple components, including, but not limited to, a faucet body, a faucet spout, a faucet hose, one or more valves for controlling water flow, hot and cold water inlet conduits, and a mixing chamber for mixing hot and cold water. Conventional manual faucet assemblies require a user to mechanically control fluid flow by operating a user interface through physical touch. Conventional automatic faucet assemblies often require a user to electronically control fluid flow by activating a proximity sensor.

In conventional faucet assemblies (both manual and automatic), the mixing chamber is often located above the sink deck and inside the faucet body. The mixing chamber may be located within a manifold assembly having several openings. The hot and cold water inlet conduits, faucet hose, and one or more valves are connected to the manifold openings. Water enters the manifold assembly from the inlet conduits, mixes in the mixing chamber, and then exits through the faucet hose. The valves may include cartridges that control water flow between the inlet conduits, mixing chamber, and/or faucet hose.

### SUMMARY

Provided are faucet assemblies comprising a below-deck mixing box. The faucet assemblies provided herein can include one or more cartridges having a central axis running through a spindle of the cartridge and horizontal to an upper surface of a sink deck. The central axis of the one or more cartridges may also run perpendicular to a central axis of a manifold cover of a manifold assembly which runs centrally through a top opening and a bottom opening of the manifold cover. In some embodiments, the central axis of a first cartridge and the central axis of the second cartridge are the same.

Conventional faucet assemblies, such as the conventional manual and automatic faucets described above, include a mixing chamber for mixing water of different temperatures. Typically, the mixing chamber is located above the sink deck and inside the faucet body. Due to space constraints inside the faucet body, the size and orientation of the various internal components, such as cartridges, are restricted. Thus, water can only flow through a faucet assembly along a limited number of paths, as determined by the size and orientation of the faucet's components. This limits the complexity of faucet designs.

Accordingly, unlike the conventional faucet assemblies described above, the faucet assemblies described herein include a below-deck mixing box. By moving the mixing chamber location from above the sink deck and inside the faucet body to below the sink deck and inside a separate mixing box as disclosed herein, more space is provided for the faucet's various components. Consequently, there are also fewer restrictions on the size and orientation of the various components. The faucet assemblies described herein include a manifold assembly and two single-control cartridges each having a central axis (passing through the spindle of the cartridge) oriented horizontally relative to an upper surface of the sink deck. (Note that faucet assemblies that include two single-control cartridges may be referred to as dual-control faucet assemblies.) One cartridge is for cold water and one cartridge is for hot water. The central axis of each of the cartridges also runs perpendicular to a central axis of the manifold cover (running centrally through a top opening and a bottom opening of the manifold cover) of a manifold assembly. The central axis of each of the two cartridges may be the same axis. Due to space constraints of conventional faucet assemblies having mixing chambers located within the faucet body and/or above deck, the orientation of the cartridges relative to the manifold assembly (and sink deck) would not be possible. Accordingly, due to the orientation of the cartridges relative to the manifold assembly and sink deck, as described herein, water can flow along different paths that would not be possible in conventional faucet assemblies.

In some embodiments, the below-deck mixing box contains a manifold assembly with five openings, hot and cold water inlet conduits, an outlet adapter configured to connect to a faucet hose, two single-control cartridges, and any number of other components to support the operation of the faucet. The two single-control cartridges control the flow of hot and cold water into the mixing chamber and are oriented horizontally relative to the sink deck. Water enters the manifold assembly from the inlet conduits, flows past the cartridges, mixes in the mixing chamber, and then exits through the outlet adapter. In some embodiments described herein, the inlet conduits are linearly connected to the manifold assembly relative to the outlet adapter.

In some embodiments, a mixing assembly for a faucet assembly is provided, comprising: a manifold; a first motor coupled to a first cartridge; and a second motor coupled to a second cartridge, wherein the mixing assembly is configured to be positioned below a deck surface onto which the faucet assembly is configured to be installed, and the mixing assembly is configured to mix hot water received from a hot water source and cold water received from a cold water source, and to deliver mixed water to the faucet assembly.

In some embodiments, the first motor and the second motor are configured to be in electronic communication with the faucet assembly, the first cartridge is configured to receive hot water from a hot water source, the second cartridge is configured to receive cold water from a cold water source, the first motor is configured to operate the first cartridge to deliver hot water to the manifold, the second motor is configured to operate the second cartridge to deliver cold water to the manifold assembly, and the manifold is configured to deliver mixed water to the faucet assembly.

In some embodiments, the manifold comprises: a left side opening configured to receive the first cartridge; a right side opening configured to receive the second cartridge; one or more bottom openings configured to receive a first inlet conduit and a second inlet conduit; and an upper opening configured to receive an outlet conduit.

In some embodiments, a central axis of the one or more bottom openings is parallel to a central axis of the upper opening.

In some embodiments, the manifold comprises a mixing chamber.

In some embodiments, the manifold comprises a manifold base and a manifold cover, wherein the manifold cover comprises a mixing chamber.

In some embodiments, the manifold base and the manifold cover comprise separate parts joined together.

In some embodiments, the manifold base and the manifold cover are an integrally formed part.

In some embodiments, the manifold comprises an engineering thermoplastic.

In some embodiments, a central horizontal axis of the first cartridge and a central horizontal axis of the second cartridge are perpendicular to a central axis of a manifold cover.

In some embodiments, a central horizontal axis of the first cartridge and a central horizontal axis of the second cartridge are the same.

In some embodiments, the mixing assembly comprises a controller configured to be in electronic communication with a faucet handle of the faucet assembly, wherein, when in a manual mode, the controller is configured to receive an electronic signal from the faucet handle, the controller is configured to instruct the first motor to operate the first cartridge to open or close to adjust a volume of hot water delivered to the manifold, and the controller is configured to instruct the second motor to operate the second cartridge to open or close to adjust a volume of cold water delivered to the manifold.

In some embodiments, the faucet handle comprises an electronic position sensor configured to be in electronic communication with the controller, wherein the controller is configured to receive a handle position signal from the electronic position sensor and to instruct the first motor and the second motor according to the handle position.

In some embodiments, the mixing assembly comprises a controller configured to be in electronic communication with a sensor of the faucet assembly, wherein, when in an automatic mode, the controller is configured to receive an electronic signal from the sensor, the controller is configured to instruct the first motor to operate the first cartridge to open or close to adjust a volume of hot water delivered to the manifold, and the controller is configured to instruct the second motor to operate the second cartridge to open or close to adjust a volume of cold water delivered to the manifold.

In some embodiments, the sensor comprises one or more of an infrared presence sensor, a capacitive sensor, a motion sensor, or a microphone.

In some embodiments, the controller is associated with a manual temperature control, and in the automatic mode, a temperature of the mixed water is delivered according to a setting of the manual temperature control.

In some embodiments, the manual temperature control comprises a knob or dial positioned at an exterior surface of a housing.

In some embodiments, the mixing assembly is configured to operate in a manual mode by operation of a faucet handle of the faucet assembly, in an automatic mode wherein a user's presence is detected by a sensor of the faucet assembly, or in both the manual mode and the automatic mode.

In some embodiments, the mixing assembly is configured to operate in the manual mode and in the automatic mode, wherein during operation of the manual mode, the automatic mode is disabled.

In some embodiments, the mixing assembly is positioned at an interior surface of a housing.

In some embodiments, the controller is positioned at an interior surface of a housing.

In some embodiments, the mixing assembly comprises a power source, wherein the controller, the faucet handle, the sensor, the first motor, the second motor, and the power source are configured to be in electronic communication.

In some embodiments, the power source, the controller, the faucet handle, the sensor, the first motor, and the second motor are configured to be in wired electronic communication.

In some embodiments, the controller is associated with one or more electric ports, each port configured to receive and couple to an electric wire.

In some embodiments, the housing comprises one or more openings to receive the one or more electric ports.

In some embodiments, the first motor is coupled to the first cartridge with a first gear assembly, and the second motor is coupled to the second cartridge with a second gear assembly.

In some embodiments, the first cartridge comprises a first spindle, the second cartridge comprises a second spindle, the first motor is configured to rotate the first spindle to open and close the first cartridge, and the second motor is configured to rotate the second spindle to open and close the second cartridge.

In some embodiments, the first spindle and the second spindle are each configured to rotate a ceramic disc to open and close the first cartridge and the second cartridge, respectively.

In some embodiments, the first motor is coupled to the first spindle with a first gear assembly and the second motor is coupled to the second spindle with a second gear assembly.

In some embodiments, the first gear assembly comprises a pinion bevel gear coupled to the first motor, and a spur bevel gear meshed with the pinion bevel gear and coupled to a first cartridge spindle, and the second gear assembly comprises a pinion bevel gear coupled to the second motor, and a spur bevel gear meshed with the pinion bevel gear and coupled to a second cartridge spindle.

In some embodiments, the first cartridge and the second cartridge are at least partially positioned in the manifold.

In some embodiments, the mixing assembly comprises a flow sensor in electronic communication with the controller.

In some embodiments, a first faucet assembly is provided, comprising: a faucet body; a faucet handle configured to control both a volume and a temperature of water exiting the faucet body; and a mixing assembly, wherein the mixing assembly comprises: a manifold; a first electric motor coupled to a first cartridge; and a second electric motor coupled to a second cartridge, wherein the mixing assembly is configured to be positioned below a deck surface onto which the faucet assembly is configured to be installed, and the mixing assembly is configured to mix hot water received from a hot water source and cold water received from a cold water source, and to deliver mixed water to the faucet assembly.

In some embodiments, the first motor and the second motor are configured to be in electronic communication with the faucet assembly, the first cartridge is configured to receive hot water from a hot water source, the second cartridge is configured to receive cold water from a cold water source, the first motor is configured to operate the first cartridge to deliver hot water to the manifold, the second motor is configured to operate the second cartridge to deliver cold water to the manifold assembly, and the manifold is configured to deliver mixed water to the faucet assembly.

In some embodiments, a central axis of the one or more bottom openings is parallel to a central axis of the upper opening.

In some embodiments, the faucet body is a kitchen faucet or a monoblock faucet.

In some embodiments, the faucet handle is a lever handle, a rotary handle, or a paddle-type handle.

In some embodiments, the manifold comprises a mixing chamber.

In some embodiments, the manifold comprises a manifold base and a manifold cover, wherein the manifold cover comprises a mixing chamber.

In some embodiments, the manifold base and the manifold cover comprise separate parts joined together.

In some embodiments, the manifold base and the manifold cover are an integrally formed part.

In some embodiments, the manifold comprises an engineering thermoplastic.

In some embodiments, a central horizontal axis of the first cartridge and a central horizontal axis of the second cartridge are perpendicular to a central axis of a manifold cover.

In some embodiments, a central horizontal axis of the first cartridge and a central horizontal axis of the second cartridge are the same.

In some embodiments, the first faucet assembly comprises a controller configured to be in electronic communication with a faucet handle of the faucet assembly, wherein, in a manual mode, the controller is configured to receive an electronic signal from the faucet handle, the controller is configured to instruct the first motor to operate the first cartridge to open or close to adjust a volume of hot water delivered to the manifold, and the controller is configured to instruct the second motor to operate the second cartridge to open or close to adjust a volume of cold water delivered to the manifold.

In some embodiments, the faucet handle comprises an electronic position sensor configured to be in electronic communication with the controller, wherein the controller is configured to receive a handle position signal from the electronic position sensor and to instruct the first motor and the second motor according to the handle position.

In some embodiments, the first faucet assembly comprises a controller configured to be in electronic communication with a sensor of the faucet assembly, wherein, when in an automatic mode, the controller is configured to receive an electronic signal from the sensor, the controller is configured to instruct the first motor to operate the first cartridge to open or close to adjust a volume of hot water delivered to the manifold, and the controller is configured to instruct the second motor to operate the second cartridge to open or close to adjust a volume of cold water delivered to the manifold.

In some embodiments, the sensor comprises one or more of an infrared presence sensor, a capacitive sensor, a motion sensor, or a microphone.

In some embodiments, the controller is associated with a manual temperature control, and in the automatic mode, a temperature of the mixed water is delivered according to a setting of the manual temperature control.

In some embodiments, the manual temperature control comprises a knob or dial positioned at an exterior surface of a housing.

In some embodiments, the first faucet assembly is configured to operate in a manual mode by operation of a faucet handle of the faucet assembly, or to operate in an automatic mode wherein a user's presence is detected by a sensor of the faucet assembly, or to operate in both the manual mode and the automatic mode.

In some embodiments, the first faucet assembly is configured to operate in the manual mode and in the automatic mode, wherein during operation of the manual mode, the automatic mode is disabled.

In some embodiments, the faucet handle is configured to be set at a handle position indicating a water temperature setting while manual mode water flow is turned OFF or remains OFF, or while automatic mode water flow is ON or OFF.

In some embodiments, in the manual mode, a temperature of the mixed water is delivered according to the water temperature setting of the faucet handle upon the user touching, pushing, or clicking the faucet handle a first time.

In some embodiments, in the manual mode, upon the user touching, pushing, or clicking the faucet handle a second time, the mixed water delivery is turned off while maintaining the faucet handle temperature setting.

In some embodiments, in the automatic mode, when the water flow is turned ON, a temperature of the mixed water is delivered according to the water temperature setting of the faucet handle when the user's presence is detected by the sensor.

In some embodiments, the controller is configured to determine the preferred water temperature based on the handle position setting and to instruct one or both of the first motor and the second motor to operate the respective cartridges according to the determined water temperature.

In some embodiments, the controller is configured to instruct the one or both of the first motor and the second motor according to the determined water temperature setting while water flow is turned OFF or remains OFF.

In some embodiments, the controller instructs the one or both of the first motor and the second motor according to the determined water temperature setting upon water flow being turned ON.

In some embodiments, the mixing assembly is positioned at an interior surface of a housing.

In some embodiments, the controller is positioned at an interior surface of a housing.

In some embodiments, the first faucet assembly comprises a power source, wherein the controller, the faucet handle, the sensor, the first motor, the second motor, and the power source are configured to be in electronic communication.

In some embodiments, the power source, the controller, the faucet handle, the sensor, the first motor, and the second motor are configured to be in wired electronic communication.

In some embodiments, the controller is associated with one or more electric ports, each port configured to receive and couple to an electric wire.

In some embodiments, the housing comprises one or more openings to receive the one or more electric ports.

In some embodiments, the first motor is coupled to the first cartridge with a first gear assembly, and the second motor is coupled to the second cartridge with a second gear assembly.

In some embodiments, the first cartridge comprises a first spindle, the second cartridge comprises a second spindle, the first motor is configured to rotate the first spindle to open and close the first cartridge, and the second motor is configured to rotate the second spindle to open and close the second cartridge.

In some embodiments, the first spindle and the second spindle are each configured to rotate a ceramic disc to open and close the first cartridge and the second cartridge, respectively.

In some embodiments, the first motor is coupled to the first spindle with a first gear assembly, and the second motor is coupled to the second spindle with a second gear assembly.

In some embodiments, the first gear assembly comprises a pinion bevel gear coupled to the first motor, and a spur bevel gear meshed with the pinion bevel gear and coupled to a first cartridge spindle, and the second gear assembly comprises a pinion bevel gear coupled to the second motor, and a spur bevel gear meshed with the pinion bevel gear and coupled to a second cartridge spindle.

In some embodiments, the first cartridge and the second cartridge are at least partially positioned in the manifold.

In some embodiments, the first faucet assembly comprises a flow sensor in electronic communication with the controller.

In some embodiments, a second faucet assembly is provided, comprising: a faucet body; a first faucet handle configured to control a volume of hot water exiting the faucet body; a second faucet handle configured to control a volume of a cold water exiting the faucet body; and a mixing assembly, wherein the mixing assembly comprises: a manifold; a first electric motor coupled to a first cartridge; and a second electric motor coupled to a second cartridge, wherein the mixing assembly is configured to be positioned below a deck surface onto which the faucet assembly is configured to be installed, and the mixing assembly is configured to mix hot water received from a hot water source and cold water received from a cold water source, and to deliver mixed water to the faucet assembly.

In some embodiments, the first motor and the second motor are configured to be in electronic communication with the faucet assembly, the first cartridge is configured to receive hot water from a hot water source, the second cartridge is configured to receive cold water from a cold water source, the first motor is configured to operate the first cartridge to deliver hot water to the manifold, the second motor is configured to operate the second cartridge to deliver cold water to the manifold assembly, and the manifold is configured to deliver mixed water to the faucet assembly.

In some embodiments, a central axis of the one or more bottom openings is parallel to a central axis of the upper opening.

In some embodiments, the faucet body is a centerset faucet or a widespread faucet.

In some embodiments, the first faucet handle and the second faucet handle are lever handles, rotary handles, or paddle-type handles.

In some embodiments, the manifold comprises a mixing chamber.

In some embodiments, the manifold comprises a manifold base and a manifold cover, wherein the manifold cover comprises a mixing chamber.

In some embodiments, the manifold base and the manifold cover comprise separate parts joined together.

In some embodiments, the manifold base and the manifold cover are an integrally formed part.

In some embodiments, the manifold comprises an engineering thermoplastic.

In some embodiments, a central horizontal axis of the first cartridge and a central horizontal axis of the second cartridge are perpendicular to a central axis of a manifold cover.

In some embodiments, a central horizontal axis of the first cartridge and a central horizontal axis of the second cartridge are the same.

In some embodiments, the second faucet assembly comprises a controller configured to be in electronic communication with a first faucet handle and a second faucet handle of the faucet assembly, wherein, when in a manual mode, the controller is configured to receive an electronic signal from one or both of the first faucet handle or the second faucet handle, the controller is configured to instruct the first motor to operate the first cartridge to open or close to adjust a volume of hot water delivered to the manifold, and the controller is configured to instruct the second motor to operate the second cartridge to open or close to adjust a volume of cold water delivered to the manifold.

In some embodiments, one or both of the first faucet handle or the second faucet handle comprises an electronic position sensor configured to be in electronic communication with the controller, wherein the controller is configured to receive a handle position signal from the electronic position sensor and to instruct the first motor and the second motor according to the handle position.

In some embodiments, the second faucet assembly comprises a controller configured to be in electronic communication with a sensor of the faucet assembly, wherein, in an automatic mode, the controller is configured to receive an electronic signal from the sensor, the controller is configured to instruct the first motor to operate the first cartridge to open or close to adjust a volume of hot water delivered to the manifold, and the controller is configured to instruct the second motor to operate the second cartridge to open or close to adjust a volume of cold water delivered to the manifold.

In some embodiments, the sensor comprises one or more of an infrared presence sensor, a capacitive sensor, a motion sensor, or a microphone.

In some embodiments, the controller is associated with a manual temperature control, and wherein in the automatic mode, a temperature of the mixed water is delivered according to a setting of the manual temperature control.

In some embodiments, the manual temperature control comprises a knob or dial positioned at an exterior surface of a housing.

In some embodiments, the second faucet assembly is configured to operate in a manual mode by operation of one or both of the first faucet handle or the second faucet handle of the faucet assembly, or to operate in an automatic mode wherein a user's presence is detected by a sensor of the faucet assembly, or to operate in both the manual mode and the automatic mode.

In some embodiments, the second faucet assembly is configured to operate in the manual mode and in the automatic mode, wherein during operation of the manual mode, the automatic mode is disabled.

In some embodiments, the mixing assembly is positioned at an interior surface of a housing.

In some embodiments, the controller is positioned at an interior surface of a housing.

In some embodiments, the second faucet assembly comprises a power source, wherein the controller, the first faucet handle, the second faucet handle, the sensor, the first motor, the second motor, and the power source are configured to be in electronic communication.

In some embodiments, the power source, the controller, the first faucet handle, the second faucet handle, the sensor, the first motor, and the second motor are configured to be in wired electronic communication.

In some embodiments, the controller is associated with one or more electric ports, each port configured to receive and couple to an electric wire.

In some embodiments, the housing comprises one or more openings to receive the one or more electric ports.

In some embodiments, the first motor is coupled to the first cartridge with a first gear assembly, and the second motor is coupled to the second cartridge with a second gear assembly.

In some embodiments, the first cartridge comprises a first spindle, the second cartridge comprises a second spindle, the first motor is configured to rotate the first spindle to open and close the first cartridge, and the second motor is configured to rotate the second spindle to open and close the second cartridge.

In some embodiments, the first spindle and the second spindle are each configured to rotate a ceramic disc to open and close the first cartridge and the second cartridge, respectively.

In some embodiments, the first motor is coupled to the first spindle with a first gear assembly, and the second motor is coupled to the second spindle with a second gear assembly.

In some embodiments, the first gear assembly comprises a pinion bevel gear coupled to the first motor, and a spur bevel gear meshed with the pinion bevel gear and coupled to a first cartridge spindle, and the second gear assembly comprises a pinion bevel gear coupled to the second motor, and a spur bevel gear meshed with the pinion bevel gear and coupled to a second cartridge spindle.

In some embodiments, the first cartridge and the second cartridge are at least partially positioned in the manifold.

In some embodiments, the second faucet assembly comprises a flow sensor in electronic communication with the controller.

### BRIEF DESCRIPTION OF THE DRAWINGS

The invention will now be described, by way of example only, with reference to the accompanying drawings, in which:

FIG. 1A illustrates a cross-sectional front view of a below-deck mixing box, according to some embodiments;

FIG. 1B illustrates an exploded isometric view of the below-deck mixing box, according to some embodiments;

FIG. 2 illustrates an exploded isometric view of a faucet assembly comprising the below-deck mixing box and a monoblock faucet, according to some embodiments;

FIG. 3 illustrates an exploded isometric view of a faucet assembly comprising the below-deck mixing box and a widespread faucet, according to some embodiments; and

FIG. 4 illustrates an exploded isometric view of a faucet assembly comprising the below-deck mixing box and a kitchen faucet, according to some embodiments; and

FIG. 5 illustrates an exploded isometric view of a faucet assembly comprising the below-deck mixing box and a centerset faucet, according to some embodiments.

### DETAILED DESCRIPTION

Provided are faucet assemblies comprising a below-deck mixing box. The faucet assemblies provided herein can include one or more cartridges having a central axis that runs horizontal to an upper surface of a sink deck and through a spindle of the cartridge. The central axis of the one or more cartridges may also run parallel to a central axis of a manifold base, wherein the central axis of a manifold base runs centrally through a left opening and a right opening of the manifold base. The manifold base may be part of a manifold assembly, which also includes a manifold cover. In some embodiments, the central axis of a first cartridge and the central axis of the second cartridge are the same. In some embodiments, the central axis of the first cartridge and/or the central axis of the second cartridge are the same as the central axis of the manifold base. In some embodiments, the central axis of the first cartridge and/or the central axis of the second cartridge run perpendicular to a central axis of a manifold cover of the manifold assembly, wherein the central axis of a manifold cover runs centrally through a top opening and a bottom opening of the manifold cover.

As described above, conventional faucet assemblies include a mixing chamber for mixing water of different temperatures (e.g., cold water from a cold water supply line and hot water from a hot water supply line). Typically, the mixing chamber is located above the sink deck and inside the faucet body. Due to space constraints inside the faucet body, the size and orientation of the various internal components, such as cartridges, are restricted. Thus, water can only flow through a faucet assembly along a limited number of paths, as determined by the size and orientation of the faucet's components. This limits the complexity of faucet designs.

Conversely, the faucet assemblies described herein include a below-deck mixing box. By moving the mixing chamber location from above the sink deck and inside the faucet body to below the sink deck and inside a separate mixing box as disclosed herein, more space is provided for the faucet's various components. Consequently, there are also fewer restrictions on the size and orientation of the various components. The faucet assemblies described herein include a manifold assembly and two single-control cartridges each having a central axis oriented horizontally relative to an upper surface of the sink deck. One cartridge is for cold water and one cartridge is for hot water. In some embodiments, the central axis of each of the cartridges also runs perpendicular to a central axis of the manifold cover. In some embodiments, the central axis of each of the cartridges runs parallel to a central axis of the manifold base. The central axis of each of the two cartridges may be the same axis. Due to space constraints of conventional faucet assemblies having mixing chambers located within the faucet body and/or above deck, the orientation of the cartridges relative to the manifold assembly (and sink deck) would not be possible. Accordingly, due to the orientation of the cartridges relative to the manifold assembly and sink deck, as described herein, water can flow along different paths that would not be possible in conventional faucet assemblies.

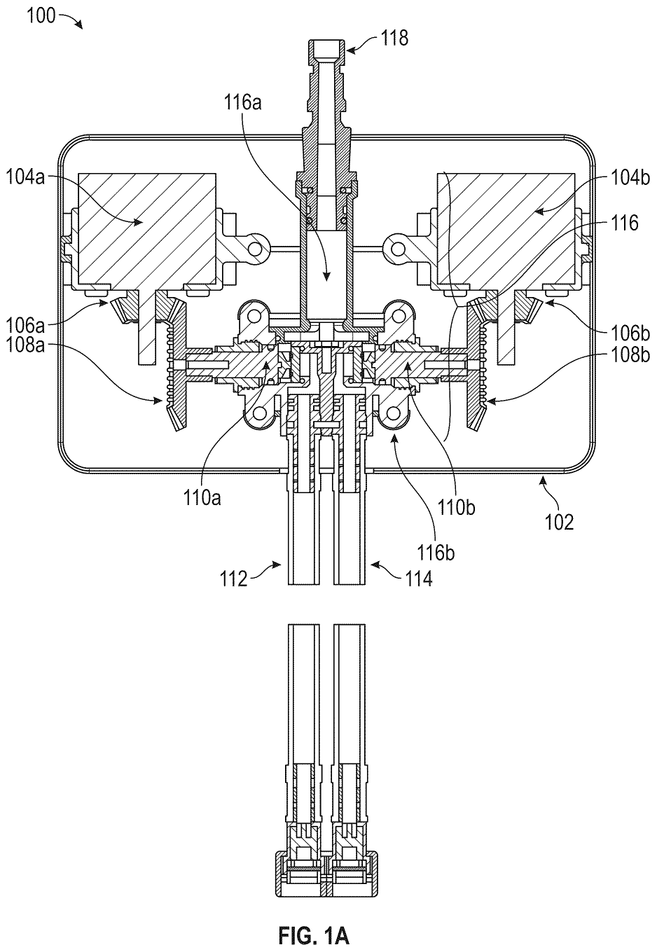

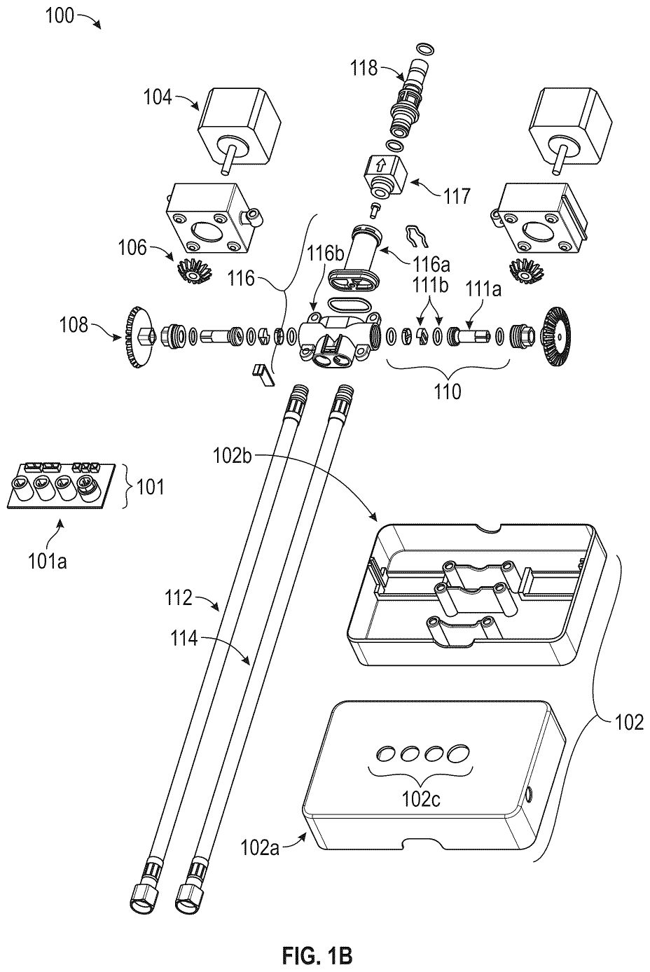

FIG. 1A illustrates a cross-sectional front view of a below-deck mixing box 100, according to some embodiments. As shown, the below-deck mixing box 100 includes a housing 102, first and second stepper motors 104a and 104b, first and second pinion gears 106a and 106b, first and second spur gears 108a and 108b, first and second cartridges 110a and 110b, a first inlet conduit 112, a second inlet conduit 114, a manifold assembly 116, a manifold cover 116a, a manifold base 116b, and an outlet adapter 118. In some embodiments, the below-deck mixing box 100 may also include a power supply, such as a battery. In some embodiments, the below-deck mixing box 100 may include a manifold assembly 116 with at least five openings. In some embodiments, a first inlet conduit 112 and a second inlet conduit 114 may be attached to two separate openings on a bottom surface of the manifold base 116b, wherein the bottom surface is the surface farthest from the sink deck. First cartridge 110a may be attached to an opening on a left surface of the manifold base 116b, wherein the left surface is a surface left of the central axis of the manifold assembly 116; similarly, second cartridge 110b may be attached to an opening on a right surface of the manifold base 116b, wherein a right surface is a surface right of the central axis of the manifold assembly 116. The central axis of the manifold assembly 116 may run centrally through a top opening and a bottom opening of the manifold assembly. In some embodiments, the central axis of the manifold assembly 116 may be the same as the central axis of the manifold cover 116a. An outlet adapter 118 may be attached to an opening on a top surface of the manifold cover 116a, which itself may be mounted to the top surface of the manifold base 116b, wherein the top surface is the surface closest to the sink deck. The outlet adapter 118 may be configured to connect to a faucet hose. In some embodiments, fluid (e.g.: water) from a fluid supply may be configured to pass from the first inlet conduit 112 or the second inlet conduit 114 to a first or second cartridge 110a or 110b attached to the manifold base 116b, then from the first or second cartridge 110a or 110b to the mixing chamber of the manifold cover 116a. The mixing box 100 does not necessarily need to be located directly below the sink deck. In some embodiments, the mixing box 100 may be located in a cabinet or enclosure elsewhere in the vicinity of the sink. Furthermore, the mixing box 100 does not necessarily need to be aligned in a certain orientation relative to the sink deck. In some embodiments, the mixing box 100 may be positioned at any angle relative to the sink deck so long as the inlet conduits 112 and 114, as well as any faucet hose attached to outlet adapter 118, remain capable of connecting to the faucet assembly.

In some embodiments, housing 102 includes a housing which protects, encloses, and supports the various components of the below-deck mixing box 100. In some embodiments, housing 102 may include a housing cover and housing base that, when mounted together, form a hard shell that may be rectangular and hollow in shape. Alternatively, the housing 102 may be any hollow shape, so long as it is spacious enough to enclose the various components of the below-deck mixing box 100. The material of housing 102 may be, for example, and without limitations, injection molded thermoplastic, corrosion resistant metal, etc. Engineering thermoplastics may include, for example, polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides (PPA), polyacetals, copolymers thereof, and blends thereof. In some embodiments, the housing 102 may include at least three openings. In some embodiments, a first inlet conduit 112 and a second inlet conduit 114 may extend through two separate openings on a bottom surface of the housing 102, wherein the bottom surface is the surface farthest from the sink deck. An outlet adapter 118 may connect to a faucet hose that extends through an opening on a top surface of the housing 102, wherein the top surface is the surface closest to the sink deck. Alternatively, in some embodiments, the housing 102 may include only two openings, such that one opening may be on a bottom surface and another opening may be on a top surface of the housing 102. In such embodiments, the first inlet conduit 112 and the second inlet conduit 114 may be adjacent, such that they may extend through the opening on a bottom surface of the housing 102.

In some embodiments, first and second stepper motors 104a and 104b include two electric motors which drive first and second pinion gears 106a and 106b. The first and second stepper motors 104a and 104b may be oriented such that the shafts of the motors point downward, i.e., away from the sink deck and parallel to the central axis of a manifold assembly 116. In some embodiments, the first and second stepper motors 104a and 104b may be contained inside the housing 102, such that the first stepper motor 104a is mounted to a holder on a left surface of the housing 102, wherein the left surface is a surface left of the central axis of the manifold assembly 116. Likewise, the second stepper motor 104b may be mounted to a holder on a right surface of the housing 102, wherein the right surface is a surface right of the central axis of the manifold assembly 116. In some embodiments, when the first and second stepper motors 104a and 104b rotate, they rotate the first and second pinion gears 106a and 106b, which in turn rotate the first and second spur gears 108a and 108b, which in turn rotate the first and second cartridges 110a and 110b. In some embodiments, another type of electric motor, for example, but not limited to, DC motors may replace one or both of first and second stepper motors 104a and 104b as the motors which drive first and second pinion gears 106a and 106b.

In some embodiments, first and second pinion gears 106a and 106b include two bevel gears which mesh with first and second spur gears 108a and 108b. In some embodiments, the first and second pinion gears 106a and 106b may be connected to the first and second stepper motors 104a and 104b such that their rotation is driven by the first and second stepper motors 104a and 104b. In such embodiments, the shafts of the first and second stepper motors 104a and 104b may extend through holes along the central axis of the first and second pinion gears 106a and 106b, thereby connecting the first and second stepper motors 104a and 104b to the first and second pinion gears 106a and 106b. In some embodiments, the first pinion gear 106a may be connected to the first stepper motor 104a and mesh with the first spur gear 108a; likewise, the second pinion gear 106b may be connected to the second stepper motor 104b and mesh with the second spur gear 108b. In some embodiments, the diameters of the first and second pinion gears 106a and 106b may be equal to each other and smaller than the diameters of the first and second spur gears 108a and 108b. In such embodiments, the preferred size ratio of the first and second pinion gears 106a and 106b to the first and second spur gears 108a and 108b may be a 1:2 size ratio. This size ratio may vary. In some embodiments, the ratio may be 1:1 to 1:10. In some embodiments, the ratio may be less than or equal to 1:1, 1:2, 1:3, 1:4, 1:5, 1:6, 1:7, 1:8, 1:9, or 1:10. In some embodiments, the ratio may be greater than or equal to 1:10, 1:9, 1:8, 1:7, 1:6, 1:5, 1:4, 1:3, 1:2, or 1:1. The central axes of the first and second pinion gears 106a and 106b may be parallel to each other and perpendicular to the central axes of the first and second spur gears 108a and 108b. In some embodiments, the spindles of first and second cartridges 110a and 110b may be driven directly by the first and second stepper motors 104a and 104b without gears. However, embodiments with gears are more space-efficient than those without gears.

In some embodiments, first and second spur gears 108a and 108b include two bevel gears which mesh with first and second pinion gears 106a and 106b. In some embodiments, the first and second spur gears 108a and 108b may be connected to the spindles of the first and second cartridges 110a and 110b such that the central axes of the first and second spur gears 108a and 108b and the central axes of the first and second cartridges 110a and 110b are the same. In such embodiments, the rotation of the first and second spur gears 108a and 108b drives the rotation of the first and second cartridges 110a and 110b. In some embodiments, the first spur gear 108a may be connected to the first cartridge 110a and mesh with the first pinion gear 106a; likewise, the second spur gear 108b may be connected to the second cartridge 110b and mesh with the second pinion gear 106b. In some embodiments, the diameters of the first and second spur gears 108a and 108b may be equal to each other and larger than the diameters of the first and second pinion gears 106a and 106b. In such embodiments, the preferred size ratio of the first and second pinion gears 106a and 106b to the first and second spur gears 108a and 108b may be a 1:2 size ratio. This size ratio may vary.

In some embodiments, first and second cartridges 110a and 110b include two single-control cartridges which control water flow either from the first inlet conduit 112 to the manifold assembly 116 or from the second inlet conduit 114 to the manifold assembly 116. Faucet assemblies that include two single-control cartridges, such as first and second cartridges 110a and 110b, may be referred to as dual-control faucet assemblies. In some embodiments, when an instruction signal from a controller is received by one or both of first and second stepper motors 104a and/or 104b, they will begin to rotate in one direction or another direction, driving the first and second pinion gears 106a and/or 106b and first and second spur gears 108a and/or 108b, which in turn allow the first and second cartridges 110a and/or 110b to rotate by a specified amount. In some embodiments, the first and second cartridges 110a and 110b may each include a piston, ball, washer, or another mechanism to control water flow. In some embodiments, first and second cartridges 110a and 110b may each include a spindle along the length of its central horizontal axis. As used herein, “flow through the cartridge” (and variations thereof) is defined as when a spindle rotates a ceramic disc to open a flow path, allowing water to flow through a cartridge such as first and second cartridges 110a and 110b. For example, in some embodiments, first and second cartridges 110a and 110b may each include a ceramic disc configured to block or allow water flow depending on the rotation of the cartridge. In such embodiments, the spindle may rotate a ceramic disc to open a flow path, allowing water to flow through the cartridge, or to close a flow path, blocking water from flowing through the cartridge. In such embodiments, opening and closing the flow paths may include fully opening, fully closing, partially opening, or partially closing the flow paths, so as to adjust the volume of hot or cold water flowing through the cartridges. In some embodiments, the spindles of first and second cartridges 110a and 110b may be connected to the first and second spur gears 108a and 108b such that the central axes of the first and second cartridges 110a and 110b and the central axes of the first and second spur gears 108a and 108b are the same. In some embodiments, the first and second cartridges 110a and 110b may be attached to openings on the manifold assembly 116 such that the first and second cartridges 110a and 110b may share the same central axis, which may be perpendicular to the central axis of the manifold assembly 116 (i.e., if the manifold assembly 116 were vertical, then the first and second cartridges 110a and 110b would be horizontal). In other words, the central horizontal axis of the first cartridge 110a and the central horizontal axis of the second cartridge 110b may be perpendicular to a central vertical axis of the manifold assembly 116. In such embodiments, the central horizontal axes of first and second cartridges 110a and 110b may be parallel to a plane of an upper surface of the sink deck surface. In some embodiments, first cartridge 110a may slot into a first threaded channel on a left surface of manifold assembly 116; similarly, second cartridge 110b may slot into a second threaded channel on a right surface of manifold assembly 116 that is opposite the first threaded channel.

In some embodiments, first inlet conduit 112 includes a hose, pipe, tubing, or adapter through which hot water flows into the manifold assembly 116. In some embodiments, the first inlet conduit 112 may have a circular cross-sectional shape. The material of first inlet conduit 112 may be, for example, and without limitations, cross-linked polyethylene (PEX) or other plastics, rubber, metal, etc. The first inlet conduit 112 may be rigid, flexible, or a combination of the two In different areas. In some embodiments, the first inlet conduit 112 may extend through an opening on a bottom surface of the housing 102, wherein the bottom surface is the surface farthest from the sink deck. In such embodiments, the first inlet conduit 112 may extend through the same opening as the second inlet conduit 114. In such embodiments, the first inlet conduit 112 may be attached to an opening on a bottom surface of the manifold assembly 116 and left of the central axis of the manifold assembly 116. Hot water flow from the first inlet conduit 112 to the manifold assembly 116 may be regulated by a first cartridge 110a. Alternatively, in some embodiments, the positions of the first inlet conduit 112 and the second inlet conduit 114 may be swapped such that the second inlet conduit 114 is positioned on the left of the first inlet conduit 112.

In some embodiments, second inlet conduit 114 includes a hose, pipe, tubing, or adapter through which cold water flows into the manifold assembly 116. In some embodiments, the second inlet conduit 114 may have a circular cross-sectional shape. The material of second inlet conduit 114 may be, for example, and without limitations, PEX or other plastics, rubber, metal, etc. The second inlet conduit 114 may be rigid, flexible, or a combination of the two in different areas. In some embodiments, the second inlet conduit 114 may extend through an opening on a bottom surface of the housing 102, wherein the bottom surface is the surface farthest from the sink deck. In such embodiments, the second inlet conduit 114 may extend through the same opening as the first inlet conduit 112. In such embodiments, the second inlet conduit 114 may be attached to an opening on a bottom surface of the manifold assembly 116 and right of the central axis of the manifold assembly 116. Cold water flow from the second inlet conduit 114 to the manifold assembly 116 may be regulated by a second cartridge 110b. Alternatively, in some embodiments, the positions of the first inlet conduit 112 and the second inlet conduit 114 may be swapped such that the second inlet conduit 114 is positioned on the left of the first inlet conduit 112.

In some embodiments, manifold assembly 116 includes manifold cover 116a and manifold base 116b. In some embodiments, when manifold cover 116a and manifold base 116b are mounted and sealed together, the resulting manifold assembly 116 forms a hard, waterproof shell which contains fluid flow paths to direct hot water from the first inlet conduit 112 and cold water from the second inlet conduit 114 into a mixing chamber. The materials of manifold assembly 116, manifold cover 116a, and manifold base 116b may be, for example, and without limitations, a combination of injection molded thermoplastic, corrosion resistant metal, etc., so long as the materials are waterproof. In some embodiments, the manifold cover 116a and manifold base 116b may be integrally formed. In some embodiments, a watertight seal may connect a bottom opening of manifold cover 116a to a top opening of manifold base 116b. In such embodiments, the watertight seal may be a rubber O-ring seal. In some embodiments, the water pressure within the manifold assembly 116 may be approximately 60 psi.

In some embodiments, manifold cover 116a includes a hollow shell with a mixing chamber for mixing water of different temperatures. In some embodiments, the manifold cover 116a may include two openings between the interior and the exterior of the hollow shell: one bottom opening on a bottom surface, and one top opening on a top surface, wherein all surface directions are relative to the sink deck (e.g.: the top surface may be the surface closest to the sink deck). In such embodiments, the bottom opening of manifold cover 116a may match in size and shape with a top opening of manifold base 116b, such that the two components may be mounted together. In such embodiments, water of different temperatures may flow from manifold base 116b into the mixing chamber of manifold cover 116a, then flow within the mixing chamber until the resulting water mixture is of an even temperature. In some embodiments, the outlet adapter 118 may be connected to the top opening on a top surface of the manifold cover 116a. In such embodiments, the water mixture may exit the mixing chamber of manifold cover 116a, then flow into the outlet adapter 118.

In some embodiments, manifold base 116b includes a hollow shell through which water of different temperatures can flow. In some embodiments, the manifold base 116b may be contained inside the housing 102, such that the manifold base 116b is mounted to a holder on an interior surface of the housing 102. In such embodiments, the manifold base 116b may include four through-holes that do not connect to the interior of the hollow shell. Pins, bolts, or other securing mechanisms may extend through these four through-holes to fasten the manifold base 116b to the housing 102. In some embodiments, the manifold base 116b may include five openings between the interior and the exterior of the hollow shell: two bottom openings on a bottom surface, one left opening on a left surface, one right opening on a right surface, and one top opening on a top surface, wherein all surface directions are relative to the sink deck (e.g.: the top surface may be the surface closest to the sink deck). In some embodiments, the first inlet conduit 112 and the second inlet conduit 114 may be connected to the two bottom openings on a bottom surface of the manifold base 116b. In such embodiments, the central axes of the first inlet conduit 112 and the second inlet conduit 114 may be parallel to each other and also parallel to the central axis of the manifold assembly 116. In some embodiments, the first cartridge 110a may be connected to the left opening, and the second cartridge 110b may be connected to the right opening. In such embodiments, first and second cartridges 110a and 110b may share the same central axis, which may be perpendicular to the central axis of the manifold assembly 116 (i.e., if the manifold assembly 116 were vertical, then the first and second cartridges 110a and 110b would be horizontal). Furthermore, in such embodiments, the left and right openings of manifold base 116b may contain threaded channels, so that the first and second cartridges 110a and 100b may slot into the threaded channels. In some embodiments, the manifold cover 116a may be connected to the top opening on a top surface of the manifold base 116b. In such embodiments, water of different temperatures may enter the manifold base 116b from the first inlet conduit 112 and the second inlet conduit 114, flow through the first and second cartridges 110a and 110b, then exit to manifold cover 116a, in which water of different temperatures may be mixed.

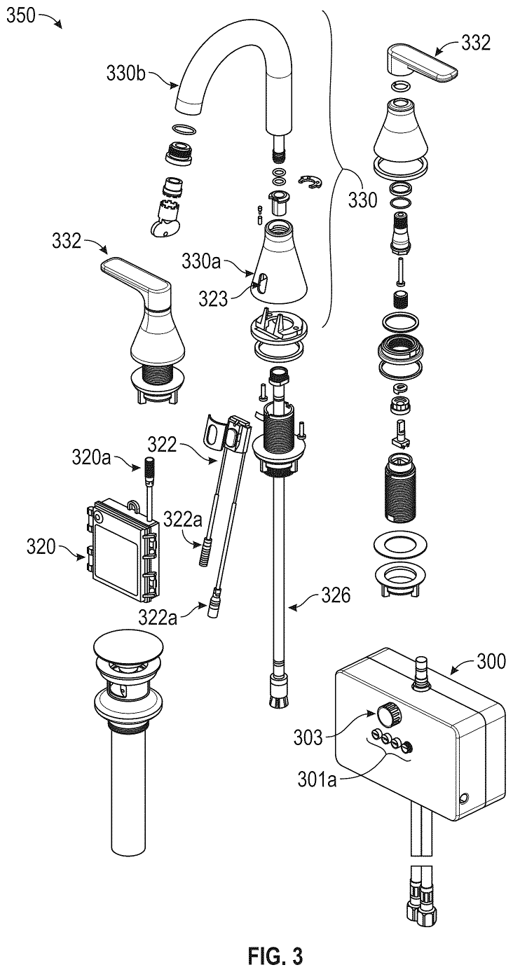

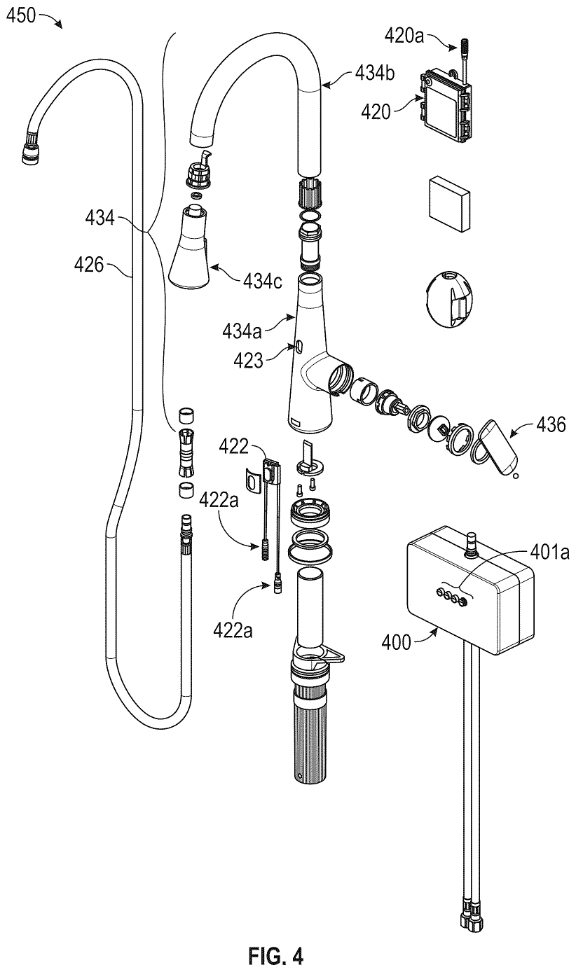

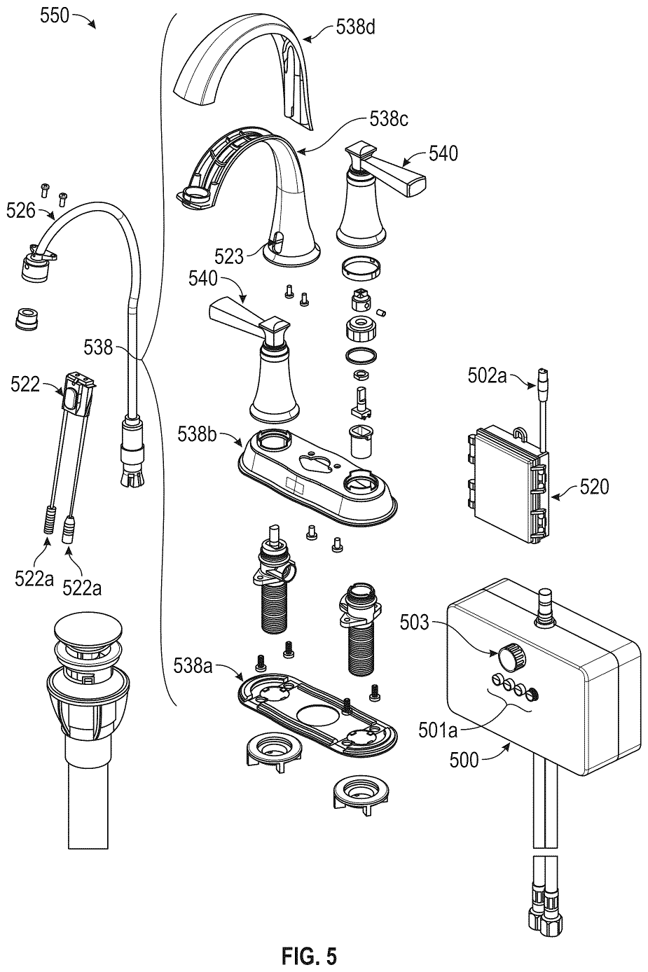

In some embodiments, outlet adapter 118 includes an adapter through which water flows out of the manifold assembly 116 after mixing. In some embodiments, the outlet adapter 118 may have a circular cross-sectional shape. The material of outlet adapter 118 may be, for example, and without limitations, PEX or other plastics, rubber, metal, etc. In some embodiments, the outlet adapter 118 may extend through an opening on a top surface of the housing 102, wherein the top surface is the surface closest to the sink deck. In some embodiments, the outlet adapter 118 may be attached to an opening on a top surface of the manifold assembly 116. In such embodiments, water may enter the manifold assembly 116 through first inlet conduit 112 and second inlet conduit 114, mix in the mixing chamber of manifold cover 116a, then exit the manifold assembly 116 through the outlet adapter 118. In some embodiments, the outlet adapter 118 may be connected to a flexible faucet hose-such as faucet hose 326 of FIGS. 3, 426 of FIG. 4, and/or 526 of FIG. 5-that transports water from the below-deck portion of the faucet assembly to the above-deck portion. In some embodiments, the outlet adapter 118 may be a barb adapter that is configured to connect the manifold assembly 116 to the faucet hose.

FIG. 1B illustrates an exploded isometric view of the below-deck mixing box 100, according to some embodiments. As shown, the below-deck mixing box 100 includes a controller 101, controller ports 101a, a housing 102, a housing cover 102a, a housing base 102b, housing openings 102c, a stepper motor 104, a pinion gear 106, a spur gear 108, a cartridge 110, a spindle 111a, ceramic discs 111b, a first inlet conduit 112, a second inlet conduit 114, a manifold assembly 116, a manifold cover 116a, a manifold base 116b, a flow sensor 117, and an outlet adapter 118. In some embodiments, one or more of the batteries, sensors, controllers, and/or motors may be in wireless electronic communication with each other. Alternatively, in some embodiments, the above components may communicate through wired connections.

In some embodiments, controller 101 includes a microcontroller, PCB, or other electronic component to control various features of the faucet assembly. The controller 101 may send and receive electronic signals and/or instructions to control the activation and rotation of stepper motors 104a and 104b. In some embodiments, the controller 101 may be electronically connected to a knob, dial, or other adjustable feature on housing 102 to preset water temperature or volume for an automatic mode. In such embodiments, in an automatic mode, a controller 101 may instruct the stepper motors 104a and 104b via instruction signals to rotate to a certain position associated with the preset water temperature. In some embodiments, the controller 101 may be configured to receive one or more electronic signals from flow sensor 117.

In some embodiments, controller 101 may include a plurality of controller ports 101a configured to receive wired connections from other electrical components. For example, controller ports 101a may receive wired connections from one or more of the batteries, sensors, and/or handles outside of the below-deck mixing box 100. In some embodiments, controller ports 101a may be configured to align with housing openings 102c such that when the controller 101 is secured inside of the housing 102, the controller ports 101a extend through the housing openings 102c and connect to wires from other electrical components outside of the housing 102.

In some embodiments, housing 102 includes housing cover 102a and housing base 102b. In some embodiments, when housing cover 102a and housing base 102b are mounted together, the resulting housing 102 may be a hard shell that is rectangular and hollow in shape. The materials of housing 102, housing cover 102a, and housing base 102b may be, for example, and without limitations, a combination of injection molded thermoplastic, corrosion resistant metal, etc. In some embodiments, an interior surface of housing cover 102a may contain protrusions that align with holes on an interior surface of housing base 102b, thereby fastening the two components together. Alternatively, in some embodiments, the interior surface of housing cover 102a may contain no protrusions, and the two components may be fastened together by other mechanisms. In some embodiments, one or both of housing cover 102a and housing base 102b may include openings for the first inlet conduit 112, second inlet conduit 114, and/or outlet adapter 118. In some embodiments, one or both of housing cover 102a and housing base 102b may include features for mounting a stepper motor 104 and/or a manifold assembly 116 onto an interior surface of the housing 102. Housing 102 may have a knob, dial, or other adjustable feature to preset water temperature for an automatic mode that is electronically connected to a controller 101. (For example, see temperature knob 303 in FIG. 3.) In some embodiments, in an automatic mode, the controller 101 may instruct the stepper motor 104 to rotate to a certain position associated with the preset water temperature. The housing 102 may also have a knob, dial, or other adjustable feature to preset water volume (i.e., flow rate) for an automatic mode. In some embodiments, an automatic mode may be configured to deliver water at a high or maximum volume.

In some embodiments, housing 102 may include a plurality of housing openings 102c configured to receive controller ports 101a. In some embodiments, housing openings 102c may be configured to align with controller ports 101a such that when the controller 101 is secured inside of the housing 102, the controller ports 101a extend through the housing openings 102c and connect to wires from other electrical components outside of the housing 102. In some embodiments, housing openings 102c may include one or more openings configured to hold a knob, dial, or other adjustable feature to preset water temperature and/or water volume. Housing 102 of FIG. 1B can include any features of housing 102 of FIG. 1A, and vice versa.

In some embodiments, stepper motor 104 includes an electric motor which drives pinion gear 106. Stepper motor 104 can include any features of first and second stepper motors 104a and/or 104b of FIG. 1A, and vice versa.

In some embodiments, pinion gear 106 includes a bevel gear which meshes with spur gear 108. Pinion gear 106 can include any features of first and second pinion gears 106a and/or 106b of FIG. 1A, and vice versa.

In some embodiments, spur gear 108 includes a bevel gear which meshes with pinion gear 106. Spur gear 108 can include any features of first and second spur gears 108a and/or 108b of FIG. 1A, and vice versa.

In some embodiments, cartridge 110 includes a single-control cartridge which controls water flow from the first inlet conduit 112 to the manifold assembly 116. In some embodiments, cartridge 110 may instead control water flow from the second inlet conduit 114 to the manifold assembly 116. Cartridge 110 can include any features of first and second cartridges 110a and/or 110b of FIG. 1A, and vice versa.

In some embodiments, spindle 111a includes a rod-shaped spindle inside cartridge 110 which rotates around a central axis along its longest dimension. In some embodiments, the spindle 111a may rotate ceramic disc 111b to open a flow path, allowing water to flow through the cartridge 110, or to close a flow path, blocking water from flowing through the cartridge 110. In such embodiments, opening and closing a flow path may include fully opening, fully closing, partially opening, or partially closing the flow path, so as to adjust the volume of hot or cold water flowing through the cartridge 110. In some embodiments, the spindle 111a may be connected to the spur gear 108 such that the central axis of the spindle 111a and the central axis of the spur gear 108 are the same. Spindle 111a can include any features of the spindles of cartridges 110a and 110b of FIG. 1A, and vice versa.

In some embodiments, ceramic discs 111b include two discs, one stationary disc and one moveable disc, inside cartridge 110 which allow or block water flow through the cartridge 110. In some embodiments, the moveable disc may be rotated such that openings in the moveable disc align with openings in the stationary disc, allowing water to flow through the ceramic discs 111b and, by extension, through the cartridge 110. Alternatively, in some embodiments, the moveable disc may be rotated such that openings in the moveable disc are blocked by the stationary disc, blocking water from flowing through the ceramic discs 111b and, by extension, through the cartridge 110. In some embodiments, the ceramic discs 111b may be connected to the end of spindle 111a such that the central axis of the spindle 111a aligns with that of the ceramic discs 111b. Ceramic discs 111b can include any features of the ceramic discs of cartridges 110a and 110b of FIG. 1A, and vice versa.

In some embodiments, first inlet conduit 112 includes a hose, pipe, tubing, or adapter through which hot water flows into the manifold assembly 216. First inlet conduit 112 of FIG. 1B can include any features of first inlet conduit 112 of FIG. 1A, and vice versa.

In some embodiments, second inlet conduit 114 includes a hose, pipe, tubing, or adapter through which cold water flows into the manifold assembly 116. Second inlet conduit 114 of FIG. 1B can include any features of second inlet conduit 114 of FIG. 1A, and vice versa.

In some embodiments, manifold assembly 116 includes manifold cover 116a and manifold base 116b. Manifold assembly 116 of FIG. 1B can include any features of manifold assembly 116 of FIG. 1A, and vice versa.

In some embodiments, manifold cover 116a includes a hollow shell with a mixing chamber for mixing water of different temperatures. Manifold cover 116a of FIG. 1B can include any features of manifold cover 116a of FIG. 1A, and vice versa.

In some embodiments, manifold base 116b includes a hollow shell through which water of different temperatures can flow. Manifold base 116b of FIG. 1B can include any features of manifold base 116b of FIG. 1A, and vice versa.

In some embodiments, flow sensor 117 includes a sensor for detecting and/or measuring water volume as it exits the manifold assembly 116. In some embodiments, the flow sensor 117 may connect the manifold assembly 116 to the outlet adapter 118. Alternatively, in some embodiments, the flow sensor 117 may be absent, and the manifold assembly 116 may connect directly to the outlet adapter 118. In some embodiments, the flow sensor 117 may send one or more electronic signals to and/or receive one or more electronic signals from the controller 101. In such embodiments, the one or more electronic signals may include water volume signals.

In some embodiments, outlet adapter 118 includes an adapter through which water flows out of the manifold assembly 116 after mixing. In some embodiments, the outlet adapter 118 may connect to a flow sensor 117, which in turn may connect to the manifold assembly 116. Outlet adapter 118 of FIG. 1B can include any features of outlet adapter 118 of FIG. 1A, and vice versa.

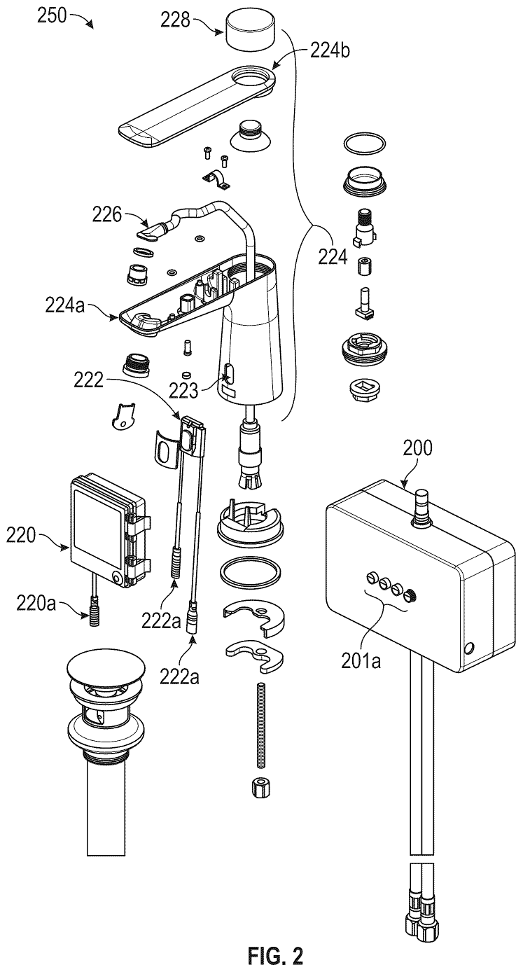

FIG. 2 illustrates an exploded isometric view of a faucet assembly 250 comprising the below-deck mixing box 200 and a monoblock faucet 224, according to some embodiments. As shown, the faucet assembly 250 includes a below-deck mixing box 200, controller ports 201a, a battery holder 220, a battery holder wire 220a, a sensor 222, sensor wires 222a, a sensor window 223, monoblock faucet 224 with faucet components 224a and 224b, a faucet hose 226, and a rotary handle 228. The faucet assembly 250 may be controlled using both the rotary handle 228 and the sensor 222. In some embodiments, the faucet assembly 250 may include an electronic position sensor, such as a rotary encoder assembly, inside the rotary handle 228.

In some embodiments, below-deck mixing box 200 includes various components that control water temperature and flow throughout the faucet assembly 250. In some embodiments, the below-deck mixing box 200 may include a housing, a controller, a manifold assembly, stepper motors, gear meshes, cartridges, first and second inlet conduits, and an outlet adapter. In some embodiments, the controller may be configured to receive one or more electronic signals from a handle position sensor, a flow sensor, and/or a presence sensor. In some embodiments, the controller may be configured to send one or more electronic instruction signals to one or more stepper motors of the below-deck mixing box 200. In some embodiments, the one or more electronic signals may comprise one or more of a water volume signal, a water temperature signal, or an operation signal. In such embodiments, the operation signal may be configured to switch the faucet assembly from an ON configuration to an OFF configuration or from an OFF configuration to an ON configuration. In some embodiments, the one or more electronic signals may be sent to the controller from a separate control mechanism. In some embodiments, one or more of the batteries, sensors, controllers, and/or motors may be in wireless electronic communication with each other. Alternatively, in some embodiments, the above components may communicate through wired connections. Below-deck mixing box 200 can include any features of below-deck mixing box 100 of FIGS. 1A and 1B, and vice versa.

In some embodiments, a plurality of controller ports 201a configured to receive wired connections from other electrical components may extend through the surface of the below-deck mixing box 200. In some embodiments, the connections between electrical components may be wireless. Controller ports 201a may be connected to the controller inside of the below-deck mixing box 200. In some embodiments, controller ports 201a may receive wired connections from one or more of the batteries, sensors, and/or handles outside of the below-deck mixing box 200. For example, controller ports 201a may be electronically coupled with the battery holder wire 220a from the battery holder 220, the sensor wires 222a from the sensor 222, and/or wires from the rotary handle 228. Controller ports 201a may include any features of controller ports 101a of FIG. 1B, and vice versa.

In some embodiments, battery holder 220 includes a housing for holding a power supply, such as a battery. In some embodiments, battery holder 220 may be positioned outside of and electronically coupled to the below-deck mixing box 200. In such embodiments, the battery holder 220 may provide power to the electronic components of the below-deck mixing box 200. In some embodiments, battery holder 220 may be rectangular in shape. Battery holder 220 may include a battery holder wire 220a for electronically coupling the battery holder 220 to controller ports 201a of below-deck mixing box 200.

In some embodiments, sensor 222 includes a proximity sensor for automatically activating the monoblock faucet 224. Sensor 222 may include one or more sensor wires 222a for electronically coupling the sensor 222 to controller ports 201a of below-deck mixing box 200. The faucet assembly 250 may be controlled using both the rotary handle 228 and the sensor 222. In some embodiments, when the presence of a person (or a person's hand or hands) is detected, the sensor 222 may send an operation signal to the controller to power the faucet ON and OFF. In such embodiments, activating the sensor 222 may set the water to a preset temperature stored by the controller of the below-deck mixing box 200. This preset temperature may be set by rotating the rotary handle 228 to a specific position. Alternatively, in some embodiments, this preset temperature may be set by rotating a knob or dial on the below-deck mixing box 200. In some preferred embodiments, sensor 222 may be an infrared sensor. Alternatively, in some embodiments, sensor 222 may be replaced by an alternative sensor, for example, but not limited to, a different type of proximity sensor, a presence sensor, a motion sensor, a voice activation sensor, an external controller, etc.

In some embodiments, sensor window 223 includes a window on the monoblock faucet 224 that allows the sensor 222 to detect the presence of a person (or a person's hand or hands) near the faucet assembly 250. The sensor 222 may be positioned inside the monoblock faucet 224 and adjacent to the sensor window 223. In some embodiments, sensor window 223 may be located on the front of faucet component 224a.

In some embodiments, monoblock faucet 224 includes faucet components 224a and 224b. In some embodiments, water may flow through a faucet hose 226 contained within the monoblock faucet 224. Faucet component 224a may include a faucet body. Faucet component 224b may include an upper shell mounted on the faucet component 224a. The material of faucet components 224a and 224b may be, for example, and without limitations, brass, stainless steel, zinc alloys, plastic, etc.

In some embodiments, faucet hose 226 includes a hose, pipe, or tubing through which water flows out of the below-deck mixing box 200 and through the monoblock faucet 224. The material of faucet hose 226 may be, for example, and without limitations, PEX or other plastics, rubber, metal, etc. The hose may be rigid, flexible, or a combination of the two in different areas. In some embodiments, the mixing chamber of the manifold assembly may be connected to an outlet adapter, which is, in turn, connected to faucet hose 226. In such embodiments, after water has mixed in the mixing chamber, it may flow through the outlet adapter and into the faucet hose 226. In some embodiments, the faucet hose 226 may be a separate component that transports water throughout the entire length of the monoblock faucet 224. Alternatively, in some embodiments, faucet hose 226 or portions thereof may be integrated directly into the construction of monoblock faucet 224, such that water flows along an interior surface of monoblock faucet 224. In some embodiments, one end of faucet hose 226 may be contained within the below-deck mixing box 200, and another end of the faucet hose 226 may be contained within the monoblock faucet 224.

In some embodiments, rotary handle 228 includes a handle for manually activating the monoblock faucet 224. In some embodiments, rotary handle 228 may include one or more wires for electronically coupling the rotary handle 228 to controller ports 201a of below-deck mixing box 200. In some embodiments, the rotary handle 228 may have a rotating and clicking function that controls temperature and water flow ON/OFF. Turning the rotary handle 228 from side to side may store a position value on the controller of below-deck mixing box 200, which may be used by each stepper motor to rotate its respective cartridge to achieve the designated temperature. In some embodiments, water flow may be turned OFF while leaving the rotary handle 228 at a preferred temperature setting. In some embodiments, rotary handle 228 may be moved to a preferred temperature setting without turning water flow ON. In either of the previous two embodiments, the controller may be configured to read the position of rotary handle 228 as a temperature setting and direct motors to deliver water at this temperature in a next automatic mode use. In some embodiments, when operating in a manual mode, the rotary handle 228 may be touched or pushed down a first time to turn water flow ON at a preset volume and at a certain temperature setting, then touched or pushed down a second time to turn water flow OFF, producing. For example, the faucet assembly 250 may remain OFF until the rotary handle 228 is clicked, i.e., touched or pushed down, after which an ON signal may be sent to the controller, powering the stepper motors and thus opening the cartridges to the stored position. The water, now unobstructed, may then flow through the cartridges, outlet adapter, and faucet hose 226 before leaving the monoblock faucet 224. The faucet assembly 250 may be turned OFF with another click of the rotary handle 228. This process may be particular to a monoblock faucet 224, for example, but is not limited to this type of faucet.

In some embodiments, turning the rotary handle 228 may adjust both water temperature and water flow/volume. The faucet assembly 250 may be turned ON or OFF with a click of the rotary handle 228, i.e., with a touch or push, when the rotary handle 228 is at a certain rotary handle position corresponding to a certain water temperature setting, thereby setting a manual mode operation to a desired water temperature and water volume. The rotary handle 228 may also be rotated while water flow is turned OFF or remains OFF, setting an automatic mode operation to a desired water temperature and water volume. When water flow is turned ON and the user's presence is detected by the sensor 222, water may be delivered according to the water temperature setting of the rotary handle 228. During this process, the controller of below-deck mixing box 200 may instruct the motors to operate their respective cartridges according to the water temperature setting. This process may be particular to a monoblock faucet 224, for example, but is not limited to this type of faucet.

In some embodiments, the rotary handle 228 may be replaced with a “paddle”-type handle like that of the kitchen faucet (see FIG. 4) and operate like the kitchen faucet.

FIG. 3 illustrates an exploded isometric view of a faucet assembly 350 comprising the below-deck mixing box 300 and a widespread faucet 330, according to some embodiments. As shown, the faucet assembly 350 includes a below-deck mixing box 300, controller ports 301a, a temperature knob 303, a battery holder 320, a battery holder wire 320a, a sensor 322, sensor wires 322a, a sensor window 323, a faucet hose 326, widespread faucet 330 with faucet components 330a and 330b, and lever handles 332. In some embodiments, the faucet assembly 350 may include electronic position sensors inside the lever handles 332.

In some embodiments, below-deck mixing box 300 includes various components that control water temperature and flow throughout the faucet assembly 350. In some embodiments, the below-deck mixing box 300 may include a housing, a controller, a manifold assembly, stepper motors, gear meshes, cartridges, first and second inlet conduits, and an outlet adapter. In some embodiments, one or more of the batteries, sensors, controllers, and/or motors may be in wireless electronic communication with each other.

Alternatively, in some embodiments, the above components may communicate through wired connections. Below-deck mixing box 300 can include any features of below-deck mixing box 100 of FIGS. 1A and 1B and/or 200 of FIG. 2, and vice versa.

In some embodiments, a plurality of controller ports 301a configured to receive wired connections from other electrical components may extend through the surface of the below-deck mixing box 300. In some embodiments, the connections between electrical components may be wireless. Controller ports 301a may be connected to the controller inside of the below-deck mixing box 300. In some embodiments, controller ports 301a may receive wired connections from one or more of the batteries, sensors, and/or handles outside of the below-deck mixing box 300. For example, controller ports 301a may be electronically coupled with the battery holder wire 320a from the battery holder 320, the sensor wires 322a from the sensor 322, and/or wires from the lever handles 332. Controller ports 301a may include any features of controller ports 101a of FIG. 1B and/or controller ports 201a of FIG. 2, and vice versa.

In some embodiments, temperature knob 303 includes a knob, dial, or other adjustable feature on an exterior surface of the below-deck mixing box 300 for presetting a water temperature for an automatic mode. Temperature knob 303 may be electronically connected to the controller of the below-deck mixing box 300. In some embodiments, temperature knob 303 may be positioned on the same exterior surface of the below-deck mixing box 300 through which the controller ports 301a extend.

In some embodiments, battery holder 320 includes a housing for holding a power supply, such as a battery. In some embodiments, battery holder 320 may be attached externally to the below-deck mixing box 300. In such embodiments, the battery holder 320 may provide power to the electronic components of the below-deck mixing box 300. In some embodiments, battery holder 320 may be rectangular in shape. Battery holder 320 may include a battery holder wire 320a for electronically coupling the battery holder 320 to controller ports 301a of below-deck mixing box 300. Battery holder 320 can include any features of battery holder 220 of FIG. 2, and vice versa.

In some embodiments, sensor 322 includes a proximity sensor for automatically activating the widespread faucet 330. Sensor 322 may include one or more sensor wires 322a for electronically coupling the sensor 322 to controller ports 301a of below-deck mixing box 300. The faucet assembly 350 may be controlled using both the lever handles 332 and the sensor 322. In some embodiments, when a user's proximity or infrared radiation is detected, the sensor 322 may send an operation signal to the controller to power the faucet ON and OFF. In such embodiments, activating the sensor 322 may set the water to a preset temperature stored by the controller of the below-deck mixing box 300. This preset temperature may be set by rotating the lever handles 332 to a specific position. Alternatively, in some embodiments, this preset temperature may be set by rotating a knob or dial on the below-deck mixing box 300. In some preferred embodiments, sensor 322 may be an infrared sensor. Alternatively, in some embodiments, sensor 322 may be replaced by an alternative sensor, for example, but not limited to, a different type of proximity sensor, a presence sensor, a motion sensor, a voice activation sensor, an external controller, etc. Sensor 322 can include any features of sensor 222 of FIG. 2, and vice versa.

In some embodiments, sensor window 323 includes a window on the widespread faucet 330 that allows the sensor 322 to detect the presence of a person (or a person's hand or hands) near the faucet assembly 350. The sensor 322 may be positioned inside the widespread faucet 330 and adjacent to the sensor window 323. In some embodiments, sensor window 323 may be located on the front of faucet component 330a. Sensor window 323 can include any features of sensor window 223 of FIG. 2, and vice versa.

In some embodiments, faucet hose 326 includes a hose, pipe, or tubing through which water flows out of the below-deck mixing box 300 and through the widespread faucet 330. In some embodiments, the faucet hose 326 may be a separate component that transports water throughout the entire length of the widespread faucet 330. Alternatively, in some embodiments, faucet hose 326 or portions thereof may be integrated directly into the construction of widespread faucet 330, such that water flows along an interior surface of widespread faucet 330. In some embodiments, one end of faucet hose 326 may be contained within the below-deck mixing box 300, and another end of the faucet hose 326 may be contained within the widespread faucet 330. Faucet hose 326 can include any features of faucet hose 226 of FIG. 2, and vice versa.

In some embodiments, widespread faucet 330 includes faucet components 330a and 330b. In some embodiments, a widespread faucet 330 may have an 8-inch spread. In some embodiments, water may flow through a faucet hose 326 contained within the widespread faucet 330. Faucet component 330a may include a faucet body. Faucet component 330b may include a faucet spout mounted on the faucet component 330a. The material of faucet components 330a and 330b may be, for example, and without limitations, brass, stainless steel, zinc alloys, plastic, etc.

In some embodiments, lever handles 332 include two handles for manually activating the widespread faucet 330. In some embodiments, lever handles 332 may include one or more wires for electronically coupling the lever handles 332 to controller ports 301a of below-deck mixing box 300. In some embodiments, lever handles 332 may include a handle positioned on the right side of the widespread faucet 330 that controls cold water flow and a handle positioned on the left side of the widespread faucet 330 that controls hot water flow. Rotating the lever handles 332 may control the two cartridges in the below-deck mixing box 300, simultaneously adjusting the temperature and the flow rate of hot or cold water. As the lever handles 332 are rotated, instruction signals may be sent to the respective stepper motor of the below-deck mixing box 300, regulating its position accordingly and opening the cartridges. The water may then flow through the cartridges, outlet adapter, and faucet hose 326 before leaving the widespread faucet 330. The faucet assembly 350 may be turned ON and OFF by rotating the lever handles 332 away from and back to their original positions, respectively. This process may be particular to a widespread faucet 330, for example, but is not limited to this type of faucet.

FIG. 4 illustrates an exploded isometric view of a faucet assembly 450 comprising the below-deck mixing box 400 and a kitchen faucet 434, according to some embodiments. As shown, the faucet assembly 450 includes a below-deck mixing box 400, controller ports 401a, a battery holder 420, a battery holder wire 420a, a sensor 422, sensor wires 422a, a sensor window 423, a faucet hose 426, kitchen faucet 434 with faucet components 434a, 434b, and 434c, and a handle 436. In some embodiments, the faucet assembly 350 may include an electronic position sensor inside the handle 436.

In some embodiments, below-deck mixing box 400 includes various components that control water temperature and flow throughout the faucet assembly 450. In some embodiments, the below-deck mixing box 400 may include a housing, a controller, a manifold assembly, stepper motors, gear meshes, cartridges, first and second inlet conduits, and an outlet adapter. In some embodiments, one or more of the batteries, sensors, controllers, and/or motors may be in wireless electronic communication with each other. Alternatively, in some embodiments, the above components may communicate through wired connections. Below-deck mixing box 400 can include any features of below-deck mixing box 100 of FIGS. 1A and 1B, 200 of FIG. 2, and/or 300 of FIG. 3, and vice versa.

In some embodiments, a plurality of controller ports 401a configured to receive wired connections from other electrical components may extend through the surface of the below-deck mixing box 400. In some embodiments, the connections between electrical components may be wireless. Controller ports 401a may include any features of controller ports 101a of FIGS. 1B, 201a of FIG. 2, and/or 301a of FIG. 3, and vice versa.

In some embodiments, battery holder 420 includes a housing for holding a power supply, such as a battery. Battery holder 420 may include a battery holder wire 420a for electronically coupling the battery holder 420 to controller ports 401a of below-deck mixing box 400. Battery holder 420 can include any features of battery holder 220 of FIGS. 2 and/or 320 of FIG. 3, and vice versa.

In some embodiments, sensor 422 includes a proximity sensor for automatically activating the kitchen faucet 434. Sensor 422 may include one or more sensor wires 422a for electronically coupling the sensor 422 to controller ports 401a of below-deck mixing box 400. The faucet assembly 450 may be controlled using both the handle 436 and the sensor 422. In some embodiments, when a user's proximity or infrared radiation is detected, the sensor 422 may send an operation signal to the controller to power the faucet ON and OFF. In such embodiments, activating the sensor 422 may set the water to a preset temperature stored by the controller of the below-deck mixing box 400. This preset temperature may be set by rotating the handle 436 to a specific position. Alternatively, in some embodiments, this preset temperature may be set by rotating a knob or dial on the below-deck mixing box 400. In some preferred embodiments, sensor 422 may be an infrared sensor. Alternatively, in some embodiments, sensor 422 may be replaced by an alternative sensor, for example, but not limited to, a different type of proximity sensor, a presence sensor, a motion sensor, a voice activation sensor, an external controller, etc. Sensor 422 can include any features of sensor 222 of FIGS. 2 and/or 322 of FIG. 3, and vice versa.

In some embodiments, sensor window 423 includes a window on the kitchen faucet 434 that allows the sensor 422 to detect the presence of a person (or a person's hand or hands) near the faucet assembly 450. The sensor 422 may be positioned inside the kitchen faucet 434 and adjacent to the sensor window 423. In some embodiments, sensor window 423 may be located on the front of faucet component 434a. Sensor window 423 can include any features of sensor window 223 of FIGS. 2 and/or 323 of FIG. 3, and vice versa.

In some embodiments, faucet hose 426 includes a hose, pipe, or tubing through which water flows out of the below-deck mixing box 400 and through the kitchen faucet 434. In some embodiments, the faucet hose 426 may be a separate component that transports water throughout the entire length of the kitchen faucet 434. Alternatively, in some embodiments, faucet hose 426 or portions thereof may be integrated directly into the construction of kitchen faucet 434, such that water flows along an interior surface of kitchen faucet 434. In some embodiments, one end of faucet hose 426 may be contained within the below-deck mixing box 400, and another end of the faucet hose 426 may be contained within the kitchen faucet 434. In such embodiments, the end of the faucet hose 426 contained within the kitchen faucet 434 may be connected to the nozzle of faucet component 434c. Faucet hose 426 can include any features of faucet hose 226 of FIGS. 2 and/or 326 of FIG. 3, and vice versa.

In some embodiments, kitchen faucet 434 includes faucet components 434a, 434b, and 434c. Faucet component 434a may include a faucet body. Faucet component 434b may include a faucet spout mounted on the faucet component 434a. Faucet component 434c may include a faucet spray head assembly that can be removably docked at an end of faucet component 434b. In some embodiments, the faucet spray head assembly of faucet component 434c may include a nozzle on one face and a faceplate with buttons that activate the spray head and toggle between two spray pattern. Faucet hose 426 may be fluidically coupled to the spray head of faucet component 434c. The material of faucet components 434a, 434b, and 434c may be, for example, and without limitations, brass, stainless steel, zinc alloys, plastic, etc.

In some embodiments, handle 436 includes a “paddle”-type handle for manually activating the kitchen faucet 434. In some embodiments, handle 436 may include one or more wires for electronically coupling the handle 436 to controller ports 401a of below-deck mixing box 400. In some embodiments, handle 436 may include a single-lever pull-down handle. In such embodiments, toggling the handle 436 may control the cartridges of the below-deck mixing box 400, simultaneously adjusting the temperature and flow rate of water reaching the kitchen faucet 434. In some embodiments, as the handle 436 is turned from side to side, instruction signals may be sent to the stepper motors of the below-deck mixing box 400, regulating their positions accordingly. In some embodiments, if the sensor 422 turns the kitchen faucet 434 OFF while the handle 436 is turned, the positions of the stepper motors may be stored on the controller of below-deck mixing box 400 until the kitchen faucet 434 is turned back ON. In some embodiments, as the handle 436 is angled up and down, instruction signals may be sent to the stepper motors of the below-deck mixing box 400 to open the cartridges to achieve the corresponding flow rate. The faucet assembly 450 may be turned ON and OFF by angling the handle 436 up from its original position and back down. When done in unison, water at the corresponding temperature and flow rate will flow through the manifold assembly of the below-deck mixing box 400. The water can then pass through the cartridges, outlet adapter, and faucet hose 426 before leaving through the spray head of kitchen faucet 434. In some embodiments, water flow may be turned OFF while leaving the handle 436 at a preferred temperature setting. In some embodiments, handle 436 may be moved to a preferred temperature setting without turning water flow ON. In either of the previous two embodiments, the controller may be configured to read the position of handle 436 as a temperature setting and direct motors to deliver water at this temperature in a next automatic mode use. In some embodiments, when operating in a manual mode, the handle 436 may be touched or pushed a first time to turn water flow ON at a preset volume at a certain temperature, then touched or pushed a second time to turn water flow OFF. The handle 436 may also be rotated while water flow is turned OFF or remains OFF, setting an automatic mode operation to a desired water temperature and water volume. When water flow is turned ON and the user's presence is detected by the sensor 422, water may be delivered according to the water temperature setting of the handle 436. During this process, the controller of below-deck mixing box 400 may instruct the motors to operate their respective cartridges according to the water temperature setting. This process may be particular to a kitchen faucet 434, for example, but is not limited to this type of faucet.

In some embodiments, moving the handle 436 may adjust both water temperature and water flow/volume. During manual mode operation, water volume may be increased by raising the handle 436 upward, away from the faucet body of kitchen faucet 434, or be decreased by lowering the handle 436 downward, toward the faucet body of kitchen faucet 434. Rotating the handle 436 from left to right may adjust water temperature. Thus, the rotary handle 436 may also be rotated while water flow remains OFF, setting an automatic mode operation to a desired water temperature. This process may be particular to a kitchen faucet 434, for example, but is not limited to this type of faucet.

In some embodiments, the handle 436 may be replaced with a rotary handle like that of the monoblock faucet (see FIG. 2) and operate like the monoblock faucet.

FIG. 5 illustrates an exploded isometric view of a faucet assembly 550 comprising the below-deck mixing box 500 and a centerset faucet 538, according to some embodiments. As shown, the faucet assembly 550 includes a below-deck mixing box 500, controller ports 501a, a temperature knob 503, a battery holder 520, a battery holder wire 520a, a sensor 522, sensor wires 522a, a faucet hose 526, centerset faucet 538 with faucet components 538a, 538b, 538c, and 538d, and handles 540. In some embodiments, the faucet assembly 550 may include electronic position sensors inside the handles 540.

In some embodiments, below-deck mixing box 500 includes various components that control water temperature and flow throughout the faucet assembly 550. In some embodiments, the below-deck mixing box 500 may include a housing, a controller, a manifold assembly, stepper motors, gear meshes, cartridges, first and second inlet conduits, and an outlet adapter. In some embodiments, one or more of the batteries, sensors, controllers, and/or motors may be in wireless electronic communication with each other. Alternatively, in some embodiments, the above components may communicate through wired connections. Below-deck mixing box 500 can include any features of below-deck mixing box 100 of FIGS. 1A and 1B, 200 of FIGS. 2, 300 of FIG. 3, and/or 400 of FIG. 4, and vice versa.

In some embodiments, a plurality of controller ports 501a configured to receive wired connections from other electrical components may extend through the surface of the below-deck mixing box 500. In some embodiments, the connections between electrical components may be wireless. Controller ports 501a may include any features of controller ports 101a of FIGS. 1B, 201a of FIGS. 2, 301a of FIG. 3, and/or 401a of FIG. 4, and vice versa.

In some embodiments, temperature knob 503 includes a knob, dial, or other adjustable feature on an exterior surface of the below-deck mixing box 500 for presetting a water temperature for an automatic mode. Temperature knob 503 may include any features of temperature knob 303 of FIG. 3, and vice versa.

In some embodiments, battery holder 520 includes a housing for holding a power supply, such as a battery. Battery holder 520 may include a battery holder wire 520a for electronically coupling the battery holder 520 to controller ports 501a of below-deck mixing box 500. Battery holder 520 can include any features of battery holder 220 of FIGS. 2, 320 of FIG. 3, and/or 420 of FIG. 4, and vice versa.

In some embodiments, sensor 522 includes a proximity sensor for automatically activating the centerset faucet 538. Sensor 522 may include one or more sensor wires 522a for electronically coupling the sensor 522 to controller ports 501a of below-deck mixing box 500. The faucet assembly 550 may be controlled using both the handles 540 and the sensor 522. In some embodiments, when a user's proximity or infrared radiation is detected, the sensor 522 may send an operation signal to the controller to power the faucet ON and OFF. In such embodiments, activating the sensor 522 may set the water to a preset temperature stored by the controller of the below-deck mixing box 500. This preset temperature may be set by rotating the handles 540 to a specific position. Alternatively, in some embodiments, this preset temperature may be set by rotating a knob or dial on the below-deck mixing box 500. In some preferred embodiments, sensor 522 may be an infrared sensor. Alternatively, in some embodiments, sensor 522 may be replaced by an alternative sensor, for example, but not limited to, a different type of proximity sensor, a presence sensor, a motion sensor, a voice activation sensor, an external controller, etc. Sensor 522 can include any features of sensor 222 of FIGS. 2, 322 of FIG. 3, and/or 422 of FIG. 4, and vice versa.

In some embodiments, sensor window 523 includes a window on the centerset faucet 538 that allows the sensor 522 to detect the presence of a person (or a person's hand or hands) near the faucet assembly 550. The sensor 522 may be positioned inside the centerset faucet 538 and adjacent to the sensor window 523. In some embodiments, sensor window 523 may be located on the front of faucet component 538c. Sensor window 523 can include any features of sensor window 223 of FIGS. 2, 323 of FIG. 3, and/or 423 of FIG. 4, and vice versa.

In some embodiments, faucet hose 526 includes a hose, pipe, or tubing through which water flows out of the below-deck mixing box 500 and through the centerset faucet 538. In some embodiments, the faucet hose 526 may be a separate component that transports water throughout the entire length of the centerset faucet 538. Alternatively, in some embodiments, faucet hose 526 or portions thereof may be integrated directly into the construction of centerset faucet 538, such that water flows along an interior surface of centerset faucet 538. In some embodiments, one end of faucet hose 526 may be contained within the below-deck mixing box 500, and another end of the faucet hose 526 may be contained within the centerset faucet 538. Faucet hose 526 can include any features of faucet hose 226 of FIGS. 2, 326 of FIG. 3, and/or 426 of FIG. 4, and vice versa.

In some embodiments, centerset faucet 538 includes faucet components 538a, 538b, 538c, and 538d. In some embodiments, a centerset faucet 538 may have a 4-inch spread. In some embodiments, water may flow through a faucet hose 526 contained within the centerset faucet 538. Faucet component 538a may include a putty plate. Faucet component 538b may include an escutcheon mounted on the faucet component 538a. Faucet component 538c may include a faucet body mounted on the faucet component 538b. Faucet component 538d may include an upper shell mounted on the faucet component 538c. The material of faucet components 538a, 538b, 538c, and 538d may be, for example, and without limitations, brass, stainless steel, zinc alloys, plastic, etc.

In some embodiments, handles 540 include two handles for manually activating the centerset faucet 538. In some embodiments, handles 540 may include one or more wires for electronically coupling the handles 540 to controller ports 501a of below-deck mixing box 500. In some embodiments, handles 540 may include a handle positioned on the right side of the centerset faucet 538 that controls cold water flow and a handle positioned on the left side of the centerset faucet 538 that controls hot water flow. Rotating the handles 540 may control the two cartridges in the below-deck mixing box 500, simultaneously adjusting the temperature and the flow rate of hot or cold water. As the handles 540 are rotated, instruction signals may be sent to the respective stepper motor of the below-deck mixing box 500, regulating its position accordingly and opening the cartridges. The water may then flow through the cartridges, outlet adapter, and faucet hose 526 before leaving the centerset faucet 538. The faucet assembly 550 may be turned ON and OFF by rotating the handles 540 away from and back to their original positions, respectively. This process may be particular to a centerset faucet 538, for example, but is not limited to this type of faucet.

Each faucet assembly described above may be capable of operating in either manual or automatic mode. In some embodiments, manual mode operation may involve activation of water flow by a handle. In some embodiments, automatic mode operation may involve activation of water flow by electronic signals received from a sensor, such as a proximity sensor, a presence sensor, a motion sensor, a voice activation sensor, an external controller, etc. In some embodiments, upon detecting the presence of a person (or a person's hand or hands) by a sensor, water flow may be turned ON. In such embodiments, upon detecting the absence of a person (or a person's hand or hands) by a sensor, water flow may be turned OFF. In some embodiments, the faucet assembly may be configured such that manual mode operation (i.e., moving a handle) will override an automatic mode operation. In some embodiments, manual mode operation may be deactivated (e.g., by toggling a switch on the housing of the below-deck mixing box). Alternatively, in some embodiments, automatic mode operation may be deactivated. This process may be particular to a monoblock faucet 224, a widespread faucet 330, a kitchen faucet 434, and centerset faucet 538, for example, but is not limited to these types of faucet.

In some embodiments, automatic mode operation may be deactivated when manual mode operation overrides or temporarily disables automatic mode operation. For example, after a controller receives a signal from a handle and transmits an instruction signal to a motor instructing the motor to rotate in one direction or another direction (manual mode operation), the controller may be configured to not receive any signals from a sensor or transmit any instruction signals (automatic mode operation). In another embodiment, upon entering manual mode operation, a controller may be configured to turn a sensor OFF, thereby preventing automatic mode operation. This process may be particular to a monoblock faucet 224, a widespread faucet 330, a kitchen faucet 434, and centerset faucet 538, for example, but is not limited to these types of faucet.

In some embodiments, automatic mode operation may override manual mode volume control but not manual mode temperature control, such that one could adjust temperature with a handle while water flow is ON during automatic mode operation.

In some embodiments, automatic mode operation may provide water-saving advantages for users. For example, while washing hands or brushing teeth, water flow may turn ON when a user's hands are near the faucet and turn OFF when a user's hands are removed from the faucet's vicinity.

In some embodiments, the mixing valve may be moved into the instructed temperature position before flow of water is activated (e.g., while a valve upstream of the mixing valve remains off). In some embodiments, the mixing valve may be moved into the instructed temperature position only upon the flow of water being activated (e.g., in a case where the mixing valve also controls absolute flow, or where the mixing valve and an upstream flow-control valve are operated simultaneously).

Following is a list of exemplary embodiments. Any one or more of the exemplary embodiments may be combined, in whole or in part, with one another and/or with other embodiments and/or features disclosed herein:
Embodiment 1. A mixing assembly for a faucet assembly, comprising:
a manifold;
a first motor coupled to a first cartridge; and
a second motor coupled to a second cartridge,
wherein the mixing assembly is configured to be positioned below a deck surface onto which the faucet assembly is configured to be installed, and
the mixing assembly is configured to mix hot water received from a hot water source and cold water received from a cold water source, and to deliver mixed water to the faucet assembly.
Embodiment 2. The mixing assembly of embodiment 1, wherein
the first motor and the second motor are configured to be in electronic communication with the faucet assembly,
the first cartridge is configured to receive hot water from a hot water source,
the second cartridge is configured to receive cold water from a cold water source,
the first motor is configured to operate the first cartridge to deliver hot water to the manifold,
the second motor is configured to operate the second cartridge to deliver cold water to the manifold assembly, and
the manifold is configured to deliver mixed water to the faucet assembly.
Embodiment 3. The mixing assembly of embodiment 1 or 2, wherein the manifold comprises:
a left side opening configured to receive the first cartridge;
a right side opening configured to receive the second cartridge;
one or more bottom openings configured to receive a first inlet conduit and a second inlet conduit; and
an upper opening configured to receive an outlet conduit.
Embodiment 4. The mixing assembly of embodiment 3, wherein a central axis of the one or more bottom openings is parallel to a central axis of the upper opening.
Embodiment 5. The mixing assembly of embodiment 1 or 2, wherein the manifold comprises a mixing chamber.
Embodiment 6. The mixing assembly of embodiment 1 or 2, wherein the manifold comprises a manifold base and a manifold cover, wherein the manifold cover comprises a mixing chamber.
Embodiment 7. The mixing assembly of embodiment 6, wherein the manifold base and the manifold cover comprise separate parts joined together.
Embodiment 8. The mixing assembly of embodiment 6, wherein the manifold base and the manifold cover are an integrally formed part.
Embodiment 9. The mixing assembly of embodiment 1 or 2, wherein the manifold comprises an engineering thermoplastic.
Embodiment 10. The mixing assembly of embodiment 1 or 2, wherein a central horizontal axis of the first cartridge and a central horizontal axis of the second cartridge are perpendicular to a central axis of a manifold cover.
Embodiment 11. The mixing assembly of embodiment 1 or 2, wherein a central horizontal axis of the first cartridge and a central horizontal axis of the second cartridge are the same.
Embodiment 12. The mixing assembly of embodiment 1 or 2, comprising a controller configured to be in electronic communication with a faucet handle of the faucet assembly,
wherein, when in a manual mode,
the controller is configured to receive an electronic signal from the faucet handle,
the controller is configured to instruct the first motor to operate the first cartridge to open or close to adjust a volume of hot water delivered to the manifold, and
the controller is configured to instruct the second motor to operate the second cartridge to open or close to adjust a volume of cold water delivered to the manifold.
Embodiment 13. The mixing assembly of embodiment 12, wherein the faucet handle comprises an electronic position sensor configured to be in electronic communication with the controller, wherein the controller is configured to receive a handle position signal from the electronic position sensor and to instruct the first motor and the second motor according to the handle position.
Embodiment 14. The mixing assembly of embodiment 1 or 2, comprising a controller configured to be in electronic communication with a sensor of the faucet assembly,
wherein, when in an automatic mode,
the controller is configured to receive an electronic signal from the sensor,
the controller is configured to instruct the first motor to operate the first cartridge to open or close to adjust a volume of hot water delivered to the manifold, and
the controller is configured to instruct the second motor to operate the second cartridge to open or close to adjust a volume of cold water delivered to the manifold.
Embodiment 15. The mixing assembly of embodiment 14, wherein the sensor comprises one or more of an infrared presence sensor, a capacitive sensor, a motion sensor, or a microphone.
Embodiment 16. The mixing assembly of embodiment 14, wherein the controller is associated with a manual temperature control, and wherein in the automatic mode, a temperature of the mixed water is delivered according to a setting of the manual temperature control.
Embodiment 17. The mixing assembly of embodiment 16, wherein the manual temperature control comprises a knob or dial positioned at an exterior surface of a housing.
Embodiment 18. The mixing assembly of embodiment 1 or 2, configured to operate in a manual mode by operation of a faucet handle of the faucet assembly, in an automatic mode wherein a user's presence is detected by a sensor of the faucet assembly, or in both the manual mode and the automatic mode.
Embodiment 19. The mixing assembly of embodiment 18, configured to operate in the manual mode and in the automatic mode, wherein during operation of the manual mode, the automatic mode is disabled.
Embodiment 20. The mixing assembly of embodiment 1 or 2, wherein the mixing assembly is positioned at an interior surface of a housing.
Embodiment 21. The mixing assembly of embodiment 12, wherein the controller is positioned at an interior surface of a housing.
Embodiment 22. The mixing assembly of embodiment 14, wherein the controller is positioned at an interior surface of a housing.
Embodiment 23. The mixing assembly of embodiment 12, comprising a power source, wherein the controller, the faucet handle, the sensor, the first motor, the second motor, and the power source are configured to be in electronic communication.
Embodiment 24. The mixing assembly of embodiment 23, wherein the power source, the controller, the faucet handle, the sensor, the first motor, and the second motor are configured to be in wired electronic communication.
Embodiment 25. The mixing assembly of embodiment 24, wherein the controller is associated with one or more electric ports, each port configured to receive and couple to an electric wire.
Embodiment 26. The mixing assembly of embodiment 25, wherein the housing comprises one or more openings to receive the one or more electric ports.
Embodiment 27. The mixing assembly of embodiment 1 or 2, wherein the first motor is coupled to the first cartridge with a first gear assembly, and the second motor is coupled to the second cartridge with a second gear assembly.
Embodiment 28. The mixing assembly of embodiment 1 or 2, wherein
the first cartridge comprises a first spindle,
the second cartridge comprises a second spindle,
the first motor is configured to rotate the first spindle to open and close the first cartridge, and
the second motor is configured to rotate the second spindle to open and close the second cartridge.
Embodiment 29. The mixing assembly of embodiment 28, wherein the first spindle and the second spindle are each configured to rotate a ceramic disc to open and close the first cartridge and the second cartridge, respectively.
Embodiment 30. The mixing assembly of embodiment 28, wherein the first motor is coupled to the first spindle with a first gear assembly and the second motor is coupled to the second spindle with a second gear assembly.
Embodiment 31. The mixing assembly of embodiment 28, wherein
the first gear assembly comprises a pinion bevel gear coupled to the first motor, and a spur bevel gear meshed with the pinion bevel gear and coupled to a first cartridge spindle,
and the second gear assembly comprises a pinion bevel gear coupled to the second motor, and a spur bevel gear meshed with the pinion bevel gear and coupled to a second cartridge spindle.
Embodiment 32. The mixing assembly of embodiment 1 or 2, wherein the first cartridge and the second cartridge are at least partially positioned in the manifold.
Embodiment 33. The mixing assembly of embodiment 12, comprising a flow sensor in electronic communication with the controller.
Embodiment 34. The mixing assembly of embodiment 14, comprising a flow sensor in electronic communication with the controller.
Embodiment 35. A faucet assembly comprising:
a faucet body;
a faucet handle configured to control both a volume and a temperature of water exiting the faucet body; and
a mixing assembly, wherein the mixing assembly comprises:
a manifold;
a first electric motor coupled to a first cartridge; and
a second electric motor coupled to a second cartridge,
   wherein
   the mixing assembly is configured to be positioned below a deck surface onto which the faucet assembly is configured to be installed, and
   the mixing assembly is configured to mix hot water received from a hot water source and cold water received from a cold water source, and to deliver mixed water to the faucet assembly.
Embodiment 36. The faucet assembly of embodiment 35, wherein
the first motor and the second motor are configured to be in electronic communication with the faucet assembly,
the first cartridge is configured to receive hot water from a hot water source,
the second cartridge is configured to receive cold water from a cold water source,
the first motor is configured to operate the first cartridge to deliver hot water to the manifold,
the second motor is configured to operate the second cartridge to deliver cold water to the manifold assembly, and
the manifold is configured to deliver mixed water to the faucet assembly.
Embodiment 37. The faucet assembly of embodiment 36, wherein a central axis of the one or more bottom openings is parallel to a central axis of the upper opening.
Embodiment 38. The faucet assembly of embodiment 35 or 36, wherein the faucet body is a kitchen faucet or a monoblock faucet.
Embodiment 39. The faucet assembly of embodiment 35 or 36, wherein the faucet handle is a lever handle, a rotary handle, or a paddle-type handle.
Embodiment 40. The faucet assembly of embodiment 35 or 36, wherein the manifold comprises a mixing chamber.
Embodiment 41. The faucet assembly of embodiment 35 or 36, wherein the manifold comprises a manifold base and a manifold cover, wherein the manifold cover comprises a mixing chamber.
Embodiment 42. The faucet assembly of embodiment 41, wherein the manifold base and the manifold cover comprise separate parts joined together.
Embodiment 43. The faucet assembly of embodiment 41, wherein the manifold base and the manifold cover are an integrally formed part.
Embodiment 44. The faucet assembly of embodiment 35 or 36, wherein the manifold comprises an engineering thermoplastic.
Embodiment 45. The faucet assembly of embodiment 35 or 36, wherein a central horizontal axis of the first cartridge and a central horizontal axis of the second cartridge are perpendicular to a central axis of a manifold cover.
Embodiment 46. The faucet assembly of embodiment 35 or 36, wherein a central horizontal axis of the first cartridge and a central horizontal axis of the second cartridge are the same.
Embodiment 47. The faucet assembly of embodiment 35 or 36, comprising a controller configured to be in electronic communication with a faucet handle of the faucet assembly,
wherein, in a manual mode,
the controller is configured to receive an electronic signal from the faucet handle,
the controller is configured to instruct the first motor to operate the first cartridge to open or close to adjust a volume of hot water delivered to the manifold, and
the controller is configured to instruct the second motor to operate the second cartridge to open or close to adjust a volume of cold water delivered to the manifold.
Embodiment 48. The faucet assembly of embodiment 47, wherein the faucet handle comprises an electronic position sensor configured to be in electronic communication with the controller, wherein the controller is configured to receive a handle position signal from the electronic position sensor and to instruct the first motor and the second motor according to the handle position.
Embodiment 49. The faucet assembly of embodiment 35 or 36, comprising a controller configured to be in electronic communication with a sensor of the faucet assembly,
wherein, when in an automatic mode,
the controller is configured to receive an electronic signal from the sensor,
the controller is configured to instruct the first motor to operate the first cartridge to open or close to adjust a volume of hot water delivered to the manifold, and
the controller is configured to instruct the second motor to operate the second cartridge to open or close to adjust a volume of cold water delivered to the manifold.
Embodiment 50. The faucet assembly of embodiment 49, wherein the sensor comprises one or more of an infrared presence sensor, a capacitive sensor, a motion sensor, or a microphone.
Embodiment 51. The faucet assembly of embodiment 49, wherein the controller is associated with a manual temperature control, and wherein in the automatic mode, a temperature of the mixed water is delivered according to a setting of the manual temperature control.
Embodiment 52. The faucet assembly of embodiment 51, wherein the manual temperature control comprises a knob or dial positioned at an exterior surface of a housing.
Embodiment 53. The faucet assembly of embodiment 35 or 36, configured to operate in a manual mode by operation of a faucet handle of the faucet assembly, or to operate in an automatic mode wherein a user's presence is detected by a sensor of the faucet assembly, or to operate in both the manual mode and the automatic mode.
Embodiment 54. The faucet assembly of embodiment 53, configured to operate in the manual mode and in the automatic mode, wherein during operation of the manual mode, the automatic mode is disabled.
Embodiment 55. The faucet assembly of embodiment 53, wherein the faucet handle is configured to be set at a handle position indicating a water temperature setting while manual mode water flow is turned OFF or remains OFF, or while automatic mode water flow is ON or OFF.
Embodiment 56. The faucet assembly of embodiment 55, wherein in the manual mode, a temperature of the mixed water is delivered according to the water temperature setting of the faucet handle upon the user touching, pushing, or clicking the faucet handle a first time.
Embodiment 57. The faucet assembly of embodiments 55 or 56, wherein in the manual mode, upon the user touching, pushing, or clicking the faucet handle a second time, the mixed water delivery is turned off while maintaining the faucet handle temperature setting.
Embodiment 58. The faucet assembly of embodiment 55, wherein in the automatic mode, when the water flow is turned ON, a temperature of the mixed water is delivered according to the water temperature setting of the faucet handle when the user's presence is detected by the sensor.
Embodiment 59. The faucet assembly of embodiment 58, wherein the controller is configured to determine the preferred water temperature based on the handle position setting and to instruct one or both of the first motor and the second motor to operate the respective cartridges according to the determined water temperature.
Embodiment 60. The faucet assembly of embodiment 59, wherein the controller is configured to instruct the one or both of the first motor and the second motor according to the determined water temperature setting while water flow is turned OFF or remains OFF.
Embodiment 61. The faucet assembly of embodiment 59, wherein the controller instructs the one or both of the first motor and the second motor according to the determined water temperature setting upon water flow being turned ON.
Embodiment 62. The faucet assembly of embodiment 35 or 36, wherein the mixing assembly is positioned at an interior surface of a housing.
Embodiment 63. The faucet assembly of embodiment 47, wherein the controller is positioned at an interior surface of a housing.
Embodiment 64. The faucet assembly of embodiment 49, wherein the controller is positioned at an interior surface of a housing.
Embodiment 65. The faucet assembly of embodiment 47, comprising a power source, wherein the controller, the faucet handle, the sensor, the first motor, the second motor, and the power source are configured to be in electronic communication.
Embodiment 66. The faucet assembly of embodiment 59, wherein the power source, the controller, the faucet handle, the sensor, the first motor, and the second motor are configured to be in wired electronic communication.
Embodiment 67. The faucet assembly of embodiment 60, wherein the controller is associated with one or more electric ports, each port configured to receive and couple to an electric wire.
Embodiment 68. The faucet assembly of embodiment 61, wherein the housing comprises one or more openings to receive the one or more electric ports.
Embodiment 69. The faucet assembly of embodiment 35 or 36, wherein the first motor is coupled to the first cartridge with a first gear assembly, and the second motor is coupled to the second cartridge with a second gear assembly.
Embodiment 70. The faucet assembly of embodiment 35 or 36, wherein
the first cartridge comprises a first spindle,
the second cartridge comprises a second spindle,
the first motor is configured to rotate the first spindle to open and close the first cartridge, and
the second motor is configured to rotate the second spindle to open and close the second cartridge.
Embodiment 71. The faucet assembly of embodiment 70, wherein the first spindle and the second spindle are each configured to rotate a ceramic disc to open and close the first cartridge and the second cartridge, respectively.
Embodiment 72. The faucet assembly of embodiment 70, wherein the first motor is coupled to the first spindle with a first gear assembly, and the second motor is coupled to the second spindle with a second gear assembly.
Embodiment 73. the faucet assembly of embodiment 70, wherein
the first gear assembly comprises a pinion bevel gear coupled to the first motor, and a spur bevel gear meshed with the pinion bevel gear and coupled to a first cartridge spindle,
and the second gear assembly comprises a pinion bevel gear coupled to the second motor, and a spur bevel gear meshed with the pinion bevel gear and coupled to a second cartridge spindle.
Embodiment 74. The faucet assembly of embodiment 35 or 36, wherein the first cartridge and the second cartridge are at least partially positioned in the manifold.
Embodiment 75. The faucet assembly of embodiment 47, comprising a flow sensor in electronic communication with the controller.
Embodiment 76. The faucet assembly of embodiment 49, comprising a flow sensor in electronic communication with the controller.
Embodiment 77. A faucet assembly comprising:
a faucet body;
a first faucet handle configured to control a volume of hot water exiting the faucet body;
a second faucet handle configured to control a volume of a cold water exiting the faucet body; and
a mixing assembly, wherein the mixing assembly comprises:
a manifold;
a first electric motor coupled to a first cartridge; and
a second electric motor coupled to a second cartridge,
   wherein
   the mixing assembly is configured to be positioned below a deck surface onto which the faucet assembly is configured to be installed, and
   the mixing assembly is configured to mix hot water received from a hot water source and cold water received from a cold water source, and to deliver mixed water to the faucet assembly.
Embodiment 78. The faucet assembly of embodiment 77, wherein
the first motor and the second motor are configured to be in electronic communication with the faucet assembly,
the first cartridge is configured to receive hot water from a hot water source,
the second cartridge is configured to receive cold water from a cold water source,
the first motor is configured to operate the first cartridge to deliver hot water to the manifold,
the second motor is configured to operate the second cartridge to deliver cold water to the manifold assembly, and
the manifold is configured to deliver mixed water to the faucet assembly.
Embodiment 79. The faucet assembly of embodiment 78, wherein a central axis of the one or more bottom openings is parallel to a central axis of the upper opening.
Embodiment 80. The faucet assembly of embodiment 77 or 78, wherein the faucet body is a centerset faucet or a widespread faucet.
Embodiment 81. The faucet assembly of embodiment 77 or 78, wherein the first faucet handle and the second faucet handle are lever handles, rotary handles, or paddle-type handles.
Embodiment 82. The faucet assembly of embodiment 77 or 78, wherein the manifold comprises a mixing chamber.
Embodiment 83. The faucet assembly of embodiment 77 or 78, wherein the manifold comprises a manifold base and a manifold cover, wherein the manifold cover comprises a mixing chamber.
Embodiment 84. The faucet assembly of embodiment 83, wherein the manifold base and the manifold cover comprise separate parts joined together.
Embodiment 85. The faucet assembly of embodiment 83, wherein the manifold base and the manifold cover are an integrally formed part.
Embodiment 86. The faucet assembly of embodiment 77 or 78, wherein the manifold comprises an engineering thermoplastic.
Embodiment 87. The faucet assembly of embodiment 77 or 78, wherein a central horizontal axis of the first cartridge and a central horizontal axis of the second cartridge are perpendicular to a central axis of a manifold cover.
Embodiment 88. The faucet assembly of embodiment 77 or 78, wherein a central horizontal axis of the first cartridge and a central horizontal axis of the second cartridge are the same.
Embodiment 89. The faucet assembly of embodiment 77 or 78, comprising a controller configured to be in electronic communication with a first faucet handle and a second faucet handle of the faucet assembly,
wherein, when in a manual mode,
the controller is configured to receive an electronic signal from one or both of the first faucet handle or the second faucet handle,
the controller is configured to instruct the first motor to operate the first cartridge to open or close to adjust a volume of hot water delivered to the manifold, and
the controller is configured to instruct the second motor to operate the second cartridge to open or close to adjust a volume of cold water delivered to the manifold.
Embodiment 90. The faucet assembly of embodiment 89, wherein one or both of the first faucet handle or the second faucet handle comprises an electronic position sensor configured to be in electronic communication with the controller, wherein the controller is configured to receive a handle position signal from the electronic position sensor and to instruct the first motor and the second motor according to the handle position.
Embodiment 91. The faucet assembly of embodiment 77 or 78, comprising a controller configured to be in electronic communication with a sensor of the faucet assembly,
wherein, in an automatic mode,
the controller is configured to receive an electronic signal from the sensor,
the controller is configured to instruct the first motor to operate the first cartridge to open or close to adjust a volume of hot water delivered to the manifold, and
the controller is configured to instruct the second motor to operate the second cartridge to open or close to adjust a volume of cold water delivered to the manifold.
Embodiment 92. The faucet assembly of embodiment 91, wherein the sensor comprises one or more of an infrared presence sensor, a capacitive sensor, a motion sensor, or a microphone.
Embodiment 93. The faucet assembly of embodiment 91, wherein the controller is associated with a manual temperature control, and wherein in the automatic mode, a temperature of the mixed water is delivered according to a setting of the manual temperature control.
Embodiment 94. The faucet assembly of embodiment 93, wherein the manual temperature control comprises a knob or dial positioned at an exterior surface of a housing.
Embodiment 95. The faucet assembly of embodiment 77 or 78, configured to operate in a manual mode by operation of one or both of the first faucet handle or the second faucet handle of the faucet assembly, or to operate in an automatic mode wherein a user's presence is detected by a sensor of the faucet assembly, or to operate in both the manual mode and the automatic mode.
Embodiment 96. The faucet assembly of embodiment 95, configured to operate in the manual mode and in the automatic mode, wherein during operation of the manual mode, the automatic mode is disabled.
Embodiment 97. The faucet assembly of embodiment 77 or 78, wherein the mixing assembly is positioned at an interior surface of a housing.
Embodiment 98. The faucet assembly of embodiment 89, wherein the controller is positioned at an interior surface of a housing.
Embodiment 99. The faucet assembly of embodiment 91, wherein the controller is positioned at an interior surface of a housing.
Embodiment 100. The faucet assembly of embodiment 89, comprising a power source, wherein the controller, the first faucet handle, the second faucet handle, the sensor, the first motor, the second motor, and the power source are configured to be in electronic communication.
Embodiment 101. The faucet assembly of embodiment 100, wherein the power source, the controller, the first faucet handle, the second faucet handle, the sensor, the first motor, and the second motor are configured to be in wired electronic communication.
Embodiment 102. The faucet assembly of embodiment 101, wherein the controller is associated with one or more electric ports, each port configured to receive and couple to an electric wire.
Embodiment 103. The faucet assembly of embodiment 102, wherein the housing comprises one or more openings to receive the one or more electric ports.
Embodiment 104. The faucet assembly of embodiment 77 or 78, wherein the first motor is coupled to the first cartridge with a first gear assembly, and the second motor is coupled to the second cartridge with a second gear assembly.
Embodiment 105. The faucet assembly of embodiment 77 or 78, wherein
the first cartridge comprises a first spindle,
the second cartridge comprises a second spindle,
the first motor is configured to rotate the first spindle to open and close the first cartridge, and
the second motor is configured to rotate the second spindle to open and close the second cartridge.
Embodiment 106. The faucet assembly of embodiment 105, wherein the first spindle and the second spindle are each configured to rotate a ceramic disc to open and close the first cartridge and the second cartridge, respectively.
Embodiment 107. The faucet assembly of embodiment 105, wherein the first motor is coupled to the first spindle with a first gear assembly, and the second motor is coupled to the second spindle with a second gear assembly.
Embodiment 108. the faucet assembly of embodiment 105, wherein
the first gear assembly comprises a pinion bevel gear coupled to the first motor, and a spur bevel gear meshed with the pinion bevel gear and coupled to a first cartridge spindle,
and the second gear assembly comprises a pinion bevel gear coupled to the second motor, and a spur bevel gear meshed with the pinion bevel gear and coupled to a second cartridge spindle.
Embodiment 109. The faucet assembly of embodiment 77 or 78, wherein the first cartridge and the second cartridge are at least partially positioned in the manifold.
Embodiment 110. The faucet assembly of embodiment 89, comprising a flow sensor in electronic communication with the controller.
Embodiment 111. The faucet assembly of embodiment 91, comprising a flow sensor in electronic communication with the controller.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A mixing assembly for a faucet assembly, comprising:
a manifold;
a first motor coupled to a first cartridge; and
a second motor coupled to a second cartridge,
wherein the mixing assembly is configured to be positioned below a deck surface onto which the faucet assembly is configured to be installed, and
the mixing assembly is configured to mix hot water received from a hot water source and cold water received from a cold water source, and to deliver mixed water to the faucet assembly.

2. The mixing assembly of claim 1, wherein:
the first motor and the second motor are configured to be in electronic communication with the faucet assembly,
the first cartridge is configured to receive hot water from a hot water source,
the second cartridge is configured to receive cold water from a cold water source,
the first motor is configured to operate the first cartridge to deliver hot water to the manifold,
the second motor is configured to operate the second cartridge to deliver cold water to the manifold assembly, and
the manifold is configured to deliver mixed water to the faucet assembly.

3. The mixing assembly of claim 1, wherein the manifold comprises a manifold base and a manifold cover, wherein the manifold cover comprises a mixing chamber.

4. The mixing assembly of claim 1, wherein a central horizontal axis of the first cartridge and a central horizontal axis of the second cartridge are perpendicular to a central axis of a manifold cover.

5. The mixing assembly of claim 1, comprising a controller configured to be in electronic communication with a sensor of the faucet assembly,
wherein, when in an automatic mode,
the controller is configured to receive an electronic signal from the sensor,
the controller is configured to instruct the first motor to operate the first cartridge to open or close to adjust a volume of hot water delivered to the manifold, and
the controller is configured to instruct the second motor to operate the second cartridge to open or close to adjust a volume of cold water delivered to the manifold.

6. The mixing assembly of claim 5, wherein the controller is associated with a manual temperature control, and wherein in the automatic mode, a temperature of the mixed water is delivered according to a setting of the manual temperature control.

7. The mixing assembly of claim 1, configured to operate in a manual mode by operation of a faucet handle of the faucet assembly, in an automatic mode wherein a user's presence is detected by a sensor of the faucet assembly, or in both the manual mode and the automatic mode.

8. The mixing assembly of claim 7, configured to operate in the manual mode and in the automatic mode, wherein during operation of the manual mode, the automatic mode is disabled.

9. The mixing assembly of claim 1, wherein the first motor is coupled to the first cartridge with a first gear assembly, and the second motor is coupled to the second cartridge with a second gear assembly.

10. The mixing assembly of claim 1, wherein:
the first cartridge comprises a first spindle,
the second cartridge comprises a second spindle,
the first motor is configured to rotate the first spindle to open and close the first cartridge, and
the second motor is configured to rotate the second spindle to open and close the second cartridge.

11. The mixing assembly of claim 10, wherein:
the first gear assembly comprises a pinion bevel gear coupled to the first motor, and a spur bevel gear meshed with the pinion bevel gear and coupled to a first cartridge spindle,
and the second gear assembly comprises a pinion bevel gear coupled to the second motor, and a spur bevel gear meshed with the pinion bevel gear and coupled to a second cartridge spindle.

12. A faucet assembly comprising:
a faucet body;
a faucet handle configured to control both a volume and a temperature of water exiting the faucet body; and
a mixing assembly, wherein the mixing assembly comprises:
a manifold;
a first electric motor coupled to a first cartridge; and
a second electric motor coupled to a second cartridge,
wherein:
the mixing assembly is configured to be positioned below a deck surface onto which the faucet assembly is configured to be installed, and
the mixing assembly is configured to mix hot water received from a hot water source and cold water received from a cold water source, and to deliver mixed water to the faucet assembly.

13. The faucet assembly of claim 12, wherein the faucet body is a kitchen faucet or a monoblock faucet.

14. The faucet assembly of claim 12, wherein the faucet handle is a lever handle, a rotary handle, or a paddle-type handle.

15. The faucet assembly of claim 12, comprising a controller configured to be in electronic communication with a faucet handle of the faucet assembly,
wherein, in a manual mode,
the controller is configured to receive an electronic signal from the faucet handle,
the controller is configured to instruct the first motor to operate the first cartridge to open or close to adjust a volume of hot water delivered to the manifold, and
the controller is configured to instruct the second motor to operate the second cartridge to open or close to adjust a volume of cold water delivered to the manifold.

16. The faucet assembly of claim 15, wherein the faucet handle comprises an electronic position sensor configured to be in electronic communication with the controller, wherein the controller is configured to receive a handle position signal from the electronic position sensor and to instruct the first motor and the second motor according to the handle position.

17. The faucet assembly of claim 12, configured to operate in a manual mode by operation of a faucet handle of the faucet assembly, or to operate in an automatic mode wherein a user's presence is detected by a sensor of the faucet assembly, or to operate in both the manual mode and the automatic mode.

18. The faucet assembly of claim 17, wherein the faucet handle is configured to be set at a handle position indicating a water temperature setting while manual mode water flow is turned OFF or remains OFF, or while automatic mode water flow is ON or OFF.

19. The faucet assembly of claim 18, wherein in the manual mode, a temperature of the mixed water is delivered according to the water temperature setting of the faucet handle upon the user touching, pushing, or clicking the faucet handle a first time.

20. The faucet assembly of claim 18, wherein in the manual mode, upon the user touching, pushing, or clicking the faucet handle a second time, the mixed water delivery is turned off while maintaining the faucet handle temperature setting.

21. The faucet assembly of claim 18, wherein in the automatic mode, when the water flow is turned ON, a temperature of the mixed water is delivered according to the water temperature setting of the faucet handle when the user's presence is detected by the sensor.

22. The faucet assembly of claim 21, wherein the controller is configured to determine the preferred water temperature based on the handle position setting and to instruct one or both of the first motor and the second motor to operate the respective cartridges according to the determined water temperature.

23. The faucet assembly of claim 22, wherein the controller is configured to instruct the one or both of the first motor and the second motor according to the determined water temperature setting while water flow is turned OFF or remains OFF.

24. The faucet assembly of claim 22, wherein the controller instructs the one or both of the first motor and the second motor according to the determined water temperature setting upon water flow being turned ON.

25. A faucet assembly comprising:
a faucet body;
a first faucet handle configured to control a volume of hot water exiting the faucet body;
a second faucet handle configured to control a volume of a cold water exiting the faucet body; and
a mixing assembly, wherein the mixing assembly comprises:
a manifold;
a first electric motor coupled to a first cartridge; and
a second electric motor coupled to a second cartridge,
wherein:
the mixing assembly is configured to be positioned below a deck surface onto which the faucet assembly is configured to be installed, and
the mixing assembly is configured to mix hot water received from a hot water source and cold water received from a cold water source, and to deliver mixed water to the faucet assembly.

26. The faucet assembly of claim 25, wherein the first faucet handle and the second faucet handle are lever handles, rotary handles, or paddle-type handles.

27. The faucet assembly of claim 25, comprising a controller configured to be in electronic communication with a first faucet handle and a second faucet handle of the faucet assembly,
wherein, when in a manual mode,
the controller is configured to receive an electronic signal from one or both of the first faucet handle or the second faucet handle,
the controller is configured to instruct the first motor to operate the first cartridge to open or close to adjust a volume of hot water delivered to the manifold, and
the controller is configured to instruct the second motor to operate the second cartridge to open or close to adjust a volume of cold water delivered to the manifold.

28. The faucet assembly of claim 27, wherein one or both of the first faucet handle or the second faucet handle comprises an electronic position sensor configured to be in electronic communication with the controller, wherein the controller is configured to receive a handle position signal from the electronic position sensor and to instruct the first motor and the second motor according to the handle position.

29. The faucet assembly of claim 25, configured to operate in a manual mode by operation of one or both of the first faucet handle or the second faucet handle of the faucet assembly, or to operate in an automatic mode wherein a user's presence is detected by a sensor of the faucet assembly, or to operate in both the manual mode and the automatic mode.
